(19) United States
(12) Patent Application Publication
(10) Pub. No.: US 2013/0201912 A1
(43) Pub. Date: Aug. 8, 2013

(54) METHOD AND APPARATUS FOR COMPRESSING CHANNEL STATE INFORMATION BASED ON PATH LOCATION INFORMATION

(71) Applicants: Hongsan Sheng, Chester Springs, PA (US); Yingxue K. Li, Exton, PA (US); Philip J. Pietraski, Huntington Station, NY (US); Carl Wang, Melville, NY (US); Ron Porat, San Diego, CA (US)

(72) Inventors: Hongsan Sheng, Chester Springs, PA (US); Yingxue K. Li, Exton, PA (US); Philip J. Pietraski, Huntington Station, NY (US); Carl Wang, Melville, NY (US); Ron Porat, San Diego, CA (US)

(73) Assignee: INTERDIGITAL PATENT HOLDINGS, INC., Wilmington, DE (US)

(21) Appl. No.: 13/698,927

(22) PCT Filed: May 18, 2011
(86) PCT No.: PCT/US11/36985

§ 371 Date: Apr. 18, 2013

Related U.S. Application Data
(60) Provisional application No. 61/348,391, filed on May 26, 2010.
(60) Provisional application No. 61/346,210, filed on May 19, 2010.

(51) Int. Cl. H04W 28/20

(52) U.S. Cl. CPC H04W 28/20
USPC 370/328

(57) ABSTRACT

Methods and apparatus are described for compressing channel state information (CSI) in time-domain based on path location information for CSI feedback. Downlink (DL) CSI is compressed in the time domain and fed back by not sending the multipath location information, or sending at a very low rate. In one method, a wireless transmit/receive unit (WTRU) selects the strongest multipath components based on channel characteristics. The multipath components are quantized in the time domain via direct or vector based quantization. The base station reconstructs a channel impulse response from the fed back quantized multipath components and applies same to precoding processing. In another method, the WTRU feeds back information associated with a narrowband portion(s) of a system spectrum. The selected narrowband portion(s) have sufficient density over time to allow good precoding per subband or across the system spectrum. Short term feedback may be augmented with long term channel information.

### CROSS REFERENCE TO RELATED APPLICATIONS

This application claims the benefit of U.S. provisional application No. 61/346,210 filed May 19, 2010; and U.S. provisional application No. 61/348,391 filed May 26, 2010, the contents of which are hereby incorporated by reference herein.

### TECHNOLOGY FIELD

This application is related to wireless communications.

### BACKGROUND

Long term evolution-advanced (LTE-A) and Institute of Electrical and Electronics Engineers (IEEE) 802.16m may use coordinated multi-point (CoMP) transmission/reception, component carrier aggregation, relays, and enhanced multi-user (MU) multiple-input multiple-output (MIMO) schemes to improve the coverage of high data rates, the cell-edge throughput and/or to increase system throughput. These features are heavily dependent on accurate channel state information (CSI) feedback signaled in the uplink (UL). More sophisticated and resource-efficient solutions for channel estimation and feedback will play a crucial role in making these techniques a practical success.

For example, to support CoMP, there are three main categories of feedback mechanisms: explicit CSI feedback, (channel as observed by the receiver, without assuming any transmission or receiver processing), implicit CSI feedback, (feedback mechanisms that use hypotheses of different transmission and/or reception processing, e.g., channel quality indicator (CQI)/precoding matrix index (PMI)/rank indicator (RI)), and wireless transmit/receive unit (WTRU) transmission of a sounding reference signal (SRS) may be used for CSI estimation at an evolved Node-B (eNB) exploiting channel reciprocity. To support these advanced technologies, feedback information may require a large amount of UL control channel capacity. Supported physical uplink control channel (PUCCH) payload sizes may be expanded for a “container” of downlink (DL) CoMP feedback.

In a frequency division duplex (FDD) system, accurate and explicit CSI feedback provides significant gain in throughput. However, feedback of detailed explicit CSI consumes valuable bandwidth on the reverse link or UL. The conventional approach is to feedback channel estimates in the frequency domain. The WTRU may need to report the subcarrier, subband, and/or wideband CSI, the rank, subband selection, PMI, and long-term CSI, which may require significant overhead consumption. As the bandwidth, the number of antennas per cell and the number of transmissions points increase, the CSI feedback overhead may become very high.

Consequently, there is significant interest in designing effective methods of feeding back explicit accurate CSI and reducing the amount of feedback of CSI without significantly penalizing the throughput of the reverse link or UL. It is also desired to have approaches that may be adapted for different channels.

### SUMMARY

Methods and apparatus are described for compressing channel state information (CSI) in time-domain based on path location information for CSI feedback. Downlink (DL) CSI may be compressed in time domain and fed back by not sending the multipath location information, or sending the multipath location information at a very low rate. In one method, a wireless transmit/receive unit (WTRU) selects a number of multipath components based on channel characteristics. The multipath components are quantized in the time domain via direct or vector based quantization. The quantized multipath component information is fed back to a base station. The base station reconstructs a channel impulse response from the fed back multipath components and applies same to precoding processing. In another method, the WTRU may communicate to the base station feedback associated with a narrowband portion or portions of a system spectrum. The base station may precode using the feedback. Subcarriers selected by the base station have sufficient density over time to allow a good precoding per subband or across the entire bandwidth of operation. The precoding may be smoothly varying over contiguous allocations permitting the receiver to exploit frequency domain correlations in channel estimation. Short term feedback may be augmented with long term information about the channel impulse response delay profile or frequency domain correlation information.

### BRIEF DESCRIPTION OF THE DRAWINGS

A more detailed understanding may be had from the following description, given by way of example in conjunction with the accompanying drawings wherein:

FIG. 1A is a system diagram of an example communications system in which one or more disclosed embodiments may be implemented;

FIG. 1B is a system diagram of an example wireless transmit/receive unit (WTRU) that may be used within the communications system illustrated in FIG. 1A;

FIG. 1C is a system diagram of an example radio access network and an example core network that may be used within the communications system illustrated in FIG. 1A;

FIG. 1D is a system diagram of another example radio access network and another example core network that may be used within the communications system illustrated in FIG. 1A;

FIG. 2 shows an example flowchart of a time domain channel state information (CSI) feedback procedure;

FIG. 3 shows an example flowchart of common processing for time domain CSI feedback procedure and implicit time domain CSI feedback based codebook quantization procedure, with specific processing for each procedure;

FIG. 4 shows an example of a scatter plot with 3 quantized phase bits and 3 quantized magnitude bits;

FIG. 5 shows an example flowchart of an implicit time domain CSI feedback based codebook quantization procedure;

FIG. 6 shows an example flowchart of time domain implicit CSI feedback;

FIG. 7 shows an example flowchart for precoding using feedback;

FIG. 8 shows a throughput comparison, (numerical results for 4×1 channel in the example of FIG. 4);

FIG. 9 shows a relative throughput gain versus frequency domain feedback of a long term evolution (LTE) codebook (numerical results for 4×1 channel in the first example);

FIG. 10 shows a throughput comparison (numerical results for 4×1 channel in a second example);

FIG. 11 shows a relative throughput gain versus frequency domain feedback of an LTE codebook (numerical results for 4×1 channel in the second example);

FIG. 12 shows a numerical throughput comparison for a 4×2 channel in a third example;

FIG. 13 shows a relative throughput gain versus frequency domain feedback of an LTE codebook in the third example;

FIG. 14 shows a numerical throughput comparison for a 4×2 channel in a fourth example;

FIG. 15 shows a relative throughput gain versus frequency domain feedback of an LTE codebook in the fourth example;

FIG. 16 shows an example flowchart for a codebook-based implicit time domain CSI feedback in multiple input single output (MISO);

FIG. 17 shows another example flowchart for a codebook-based implicit time domain CSI feedback in MISO;

FIG. 18 shows an example flowchart for a codebook-based implicit time domain feedback in multiple input multiple output (MIMO); and

FIG. 19 shows another example flowchart for a codebook-based implicit time domain feedback in MIMO.

### DETAILED DESCRIPTION

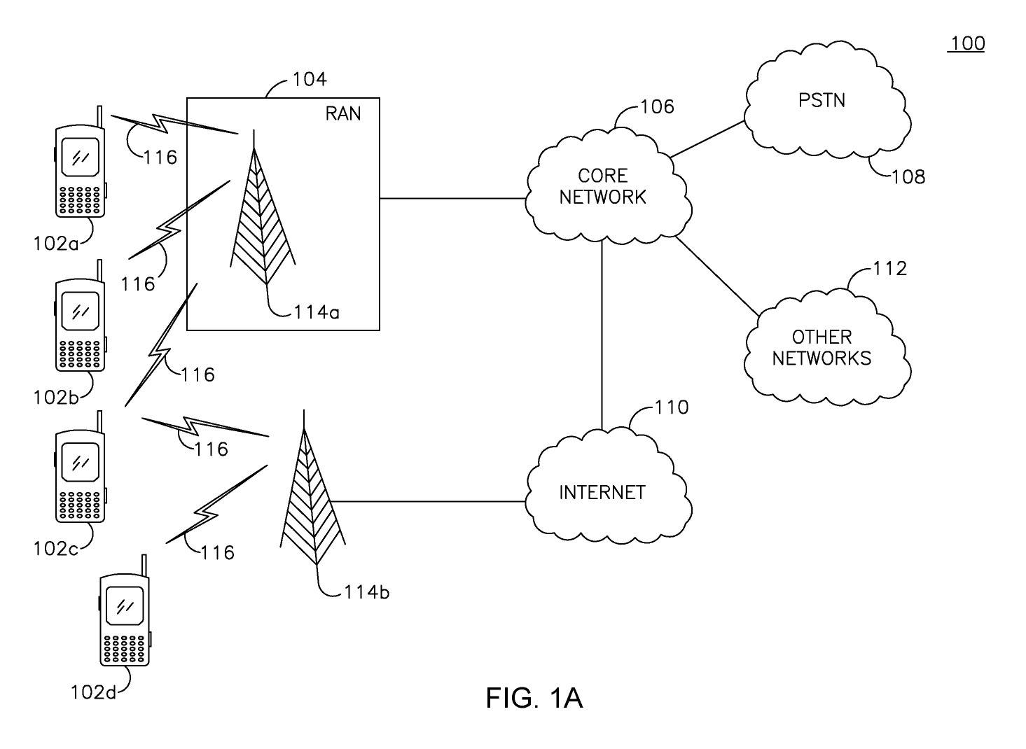

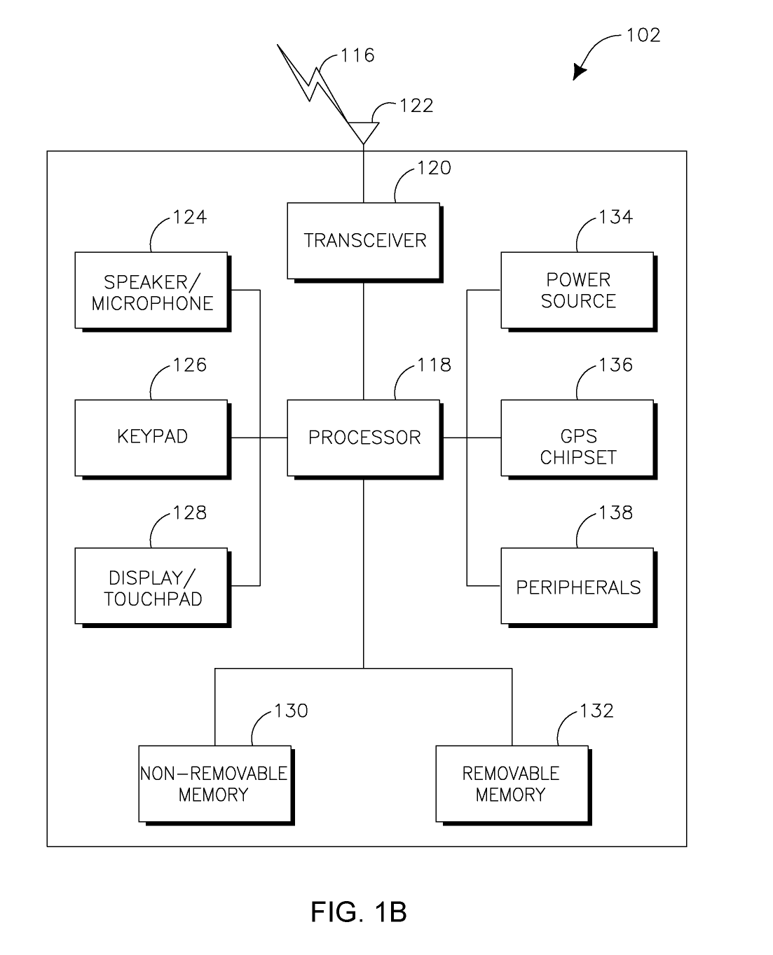

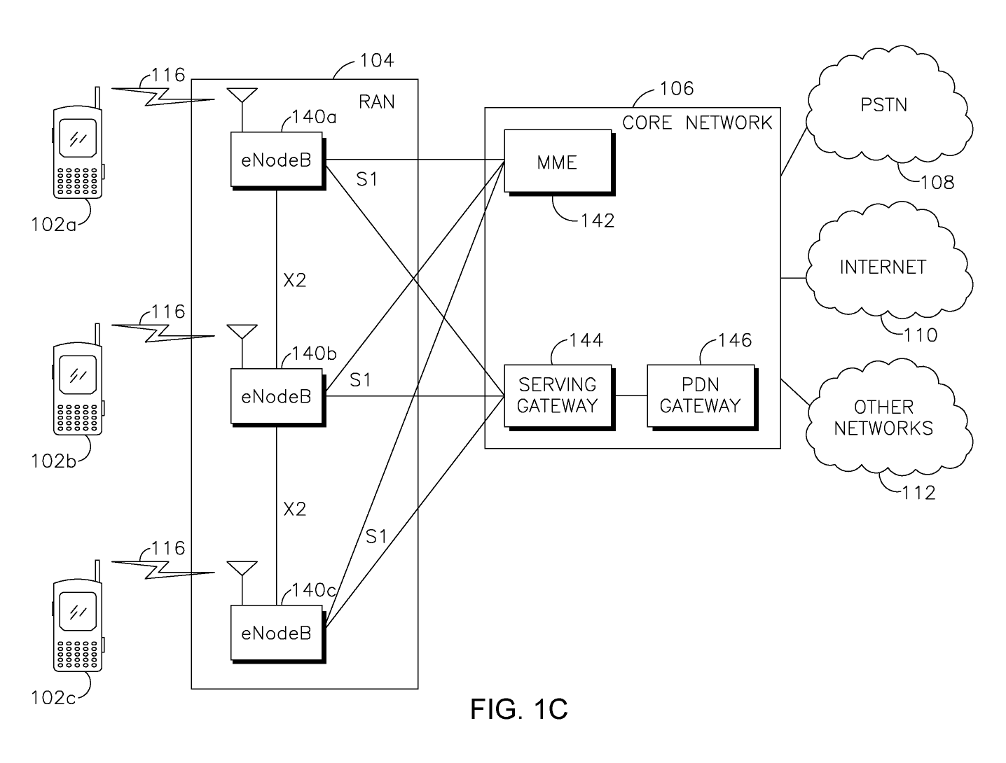

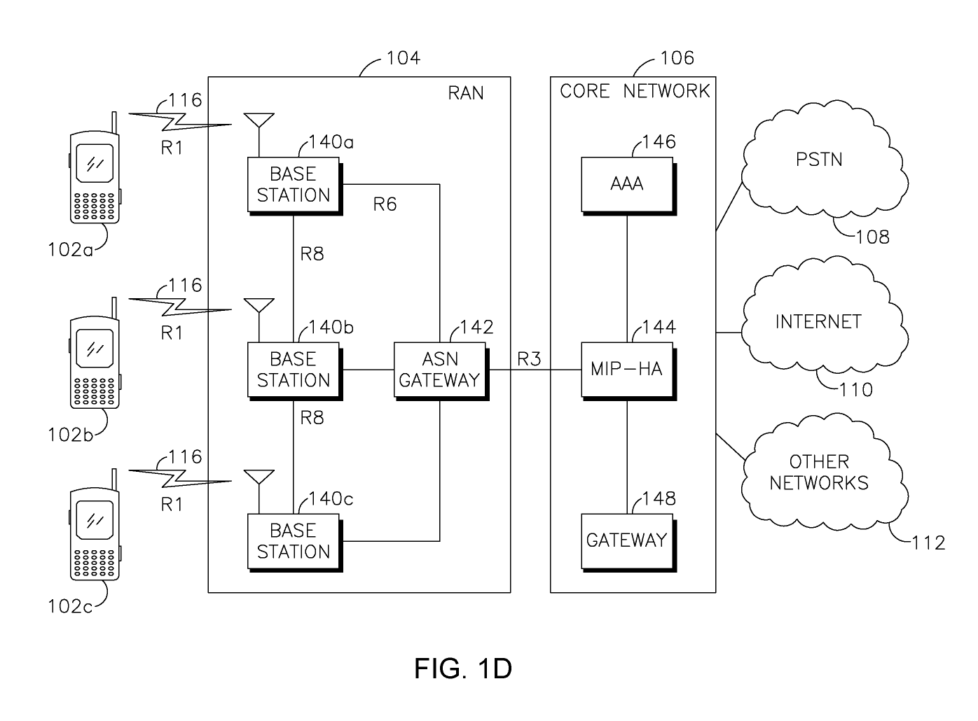

FIG. 1A is a diagram of an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), and the like.

As shown in FIG. 1A, the communications system 100 may include wireless transmit/receive units (WTRUs) 102a, 102b, 102c, 102d, a radio access network (RAN) 104, a core network 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d may be configured to transmit and/or receive wireless signals and may include user equipment (UE), a mobile station, a fixed or mobile subscriber unit, a pager, a cellular telephone, a personal digital assistant (PDA), a smartphone, a laptop, a netbook, a personal computer, a wireless sensor, consumer electronics, and the like.

The communications systems 100 may also include a base station 114a and a base station 114b. Each of the base stations 114a, 114b may be any type of device configured to wirelessly interface with at least one of the WTRUs 102a, 102b, 102c, 102d to facilitate access to one or more communication networks, such as the core network 106, the Internet 110, and/or the networks 112. By way of example, the base stations 114a, 114b may be a base transceiver station (BTS), a Node-B, an eNode B, a Home Node B, a Home eNode B, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, etc. The base station 114a and/or the base station 114b may be configured to transmit and/or receive wireless signals within a particular geographic region, which may be referred to as a cell (not shown). The cell may further be divided into cell sectors. For example, the cell associated with the base station 114a may be divided into three sectors. Thus, in one embodiment, the base station 114a may include three transceivers, i.e., one for each sector of the cell. In another embodiment, the base station 114a may employ multiple-input multiple output (MIMO) technology and, therefore, may utilize multiple transceivers for each sector of the cell.

The base stations 114a, 114b may communicate with one or more of the WTRUs 102a, 102b, 102c, 102d over an air interface 116, which may be any suitable wireless communication link (e.g., radio frequency (RF), microwave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In another embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A).

In other embodiments, the base station 114a and the WTRUs 102a, 102b, 102c may implement radio technologies such as IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, and the like. In one embodiment, the base station 114b and the WTRUs 102c, 102d may implement a radio technology such as IEEE 802.11 to establish a wireless local area network (WLAN). In another embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, etc.) to establish a picocell or femtocell. As shown in FIG. 1A, the base station 114b may have a direct connection to the Internet 110. Thus, the base station 114b may not be required to access the Internet 110 via the core network 106.

The RAN 104 may be in communication with the core network 106, which may be any type of network configured to provide voice, data, applications, and/or voice over internet protocol (VoIP) services to one or more of the WTRUs 102a, 102b, 102c, 102d. For example, the core network 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the core network 106 may be in direct or indirect communication with other RANs that employ the same RAT as the RAN 104 or a different RAT. For example, in addition to being connected to the RAN 104, which may be utilizing an E-UTRA radio technology, the core network 106 may also be in communication with another RAN (not shown) employing a GSM radio technology.

The core network 106 may also serve as a gateway for the WTRUs 102a, 102b, 102c, 102d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and the internet protocol (IP) in the TCP/IP internet protocol suite. The networks 112 may include wired or wireless communications networks owned and/or operated by other service providers. For example, the networks 112 may include another core network connected to one or more RANs, which may employ the same RAT as the RAN 104 or a different RAT.

Some or all of the WTRUs 102a, 102b, 102c, 102d in the communications system 100 may include multi-mode capabilities, i.e., the WTRUs 102a, 102b, 102c, 102d may include multiple transceivers for communicating with different wireless networks over different wireless links. For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram of an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and other peripherals 138. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In another embodiment, the transmit/receive element 122 may be an emitter/detector configured to transmit and/or receive IR, UV, or visible light signals, for example. In yet another embodiment, the transmit/receive element 122 may be configured to transmit and receive both RF and light signals. It will be appreciated that the transmit/receive element 122 may be configured to transmit and/or receive any combination of wireless signals.

In addition, although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as UTRA and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs or video), a universal serial bus (USB) port, a vibration device, a television transceiver, a hands free headset, a Bluetooth® module, a frequency modulated (FM) radio unit, a digital music player, a media player, a video game player module, an Internet browser, and the like.

FIG. 1C is a system diagram of the RAN 104 and the core network 106 according to an embodiment. As noted above, the RAN 104 may employ an E-UTRA radio technology to communicate with the WTRUs 102a, 102b, 102c over the air interface 116. The RAN 104 may also be in communication with the core network 106. FIG. 1D is a system diagram of the RAN 104 and the core network 106 according to an embodiment. The RAN 104 may be an access service network (ASN) that employs IEEE 802.16 radio technology to communicate with the WTRUs 102a, 102b, 102c over the air interface 116. As will be further discussed below, the communication links between the different functional entities of the WTRUs 102a, 102b, 102c, the RAN 104, and the core network 106 may be defined as reference points.

As shown in FIG. 1D, the RAN 104 may include base stations 140a, 140b, 140c, and an ASN gateway 142, though it will be appreciated that the RAN 104 may include any number of base stations and ASN gateways while remaining consistent with an embodiment. The base stations 140a, 140b, 140c may each be associated with a particular cell (not shown) in the RAN 104 and may each include one or more transceivers for communicating with the WTRUs 102a, 102b, 102c over the air interface 116. In one embodiment, the base stations 140a, 140b, 140c may implement MIMO technology. Thus, the base station 140a, for example, may use multiple antennas to transmit wireless signals to, and receive wireless signals from, the WTRU 102a. The base stations 140a, 140b, 140c may also provide mobility management functions, such as handoff triggering, tunnel establishment, radio resource management, traffic classification, quality of service (QoS) policy enforcement, and the like. The ASN gateway 142 may serve as a traffic aggregation point and may be responsible for paging, caching of subscriber profiles, routing to the core network 106, and the like.

The air interface 116 between the WTRUs 102a, 102b, 102c and the RAN 104 may be defined as an R1 reference point that implements the IEEE 802.16 specification. In addition, each of the WTRUs 102a, 102b, 102c may establish a logical interface (not shown) with the core network 106. The logical interface between the WTRUs 102a, 102b, 102c and the core network 106 may be defined as an R2 reference point, which may be used for authentication, authorization, IP host configuration management, and/or mobility management.

The communication link between each of the base stations 140a, 140b, 140c may be defined as an R8 reference point that includes protocols for facilitating WTRU handovers and the transfer of data between base stations. The communication link between the base stations 140a, 140b, 140c and the ASN gateway 215 may be defined as an R6 reference point. The R6 reference point may include protocols for facilitating mobility management based on mobility events associated with each of the WTRUs 102a, 102b, 100c.

As shown in FIG. 1D, the RAN 104 may be connected to the core network 106. The communication link between the RAN 104 and the core network 106 may defined as an R3 reference point that includes protocols for facilitating data transfer and mobility management capabilities, for example. The core network 106 may include a mobile IP home agent (MIP-HA) 144, an authentication, authorization, accounting (AAA) server 146, and a gateway 148. While each of the foregoing elements are depicted as part of the core network 106, it will be appreciated that any one of these elements may be owned and/or operated by an entity other than the core network operator.

The MIP-HA may be responsible for IP address management, and may enable the WTRUs 102a, 102b, 102c to roam between different ASNs and/or different core networks. The MIP-HA 144 may provide the WTRUs 102a, 102b, 102c with access to packet-switched networks, such as the Internet 110, to facilitate communications between the WTRUs 102a, 102b, 102c and IP-enabled devices. The AAA server 146 may be responsible for user authentication and for supporting user services. The gateway 148 may facilitate interworking with other networks. For example, the gateway 148 may provide the WTRUs 102a, 102b, 102c with access to circuit-switched networks, such as the PSTN 108, to facilitate communications between the WTRUs 102a, 102b, 102c and traditional land-line communications devices. In addition, the gateway 148 may provide the WTRUs 102a, 102b, 102c with access to the networks 112, which may include other wired or wireless networks that are owned and/or operated by other service providers.

Although not shown in FIG. 1D, it will be appreciated that the RAN 104 may be connected to other ASNs and the core network 106 may be connected to other core networks. The communication link between the RAN 104 the other ASNs may be defined as an R4 reference point, which may include protocols for coordinating the mobility of the WTRUs 102a, 102b, 102c between the RAN 104 and the other ASNs. The communication link between the core network 106 and the other core networks may be defined as an R5 reference, which may include protocols for facilitating interworking between home core networks and visited core networks.

The RAN 104 may include eNode-Bs 140a, 140b, 140c, though it will be appreciated that the RAN 104 may include any number of eNode-Bs while remaining consistent with an embodiment. The eNode-Bs 140a, 140b, 140c may each include one or more transceivers for communicating with the WTRUs 102a, 102b, 102c over the air interface 116. In one embodiment, the eNode-Bs 140a, 140b, 140c may implement MIMO technology. Thus, the eNode-B 140a, for example, may use multiple antennas to transmit wireless signals to, and receive wireless signals from, the WTRU 102a.

Each of the eNode-Bs 140a, 140b, 140c may be associated with a particular cell (not shown) and may be configured to handle radio resource management decisions, handover decisions, scheduling of users in the uplink and/or downlink, and the like. As shown in FIG. 1C, the eNode-Bs 140a, 140b, 140c may communicate with one another over an X2 interface.

The core network 106 shown in FIG. 1C may include a mobility management gateway (MME) 142, a serving gateway 144, and a packet data network (PDN) gateway 146. While each of the foregoing elements are depicted as part of the core network 106, it will be appreciated that any one of these elements may be owned and/or operated by an entity other than the core network operator.

The MME 142 may be connected to each of the eNode-Bs 142a, 142b, 142c in the RAN 104 via an S1 interface and may serve as a control node. For example, the MME 142 may be responsible for authenticating users of the WTRUs 102a, 102b, 102c, bearer activation/deactivation, selecting a particular serving gateway during an initial attach of the WTRUs 102a, 102b, 102c, and the like. The MME 142 may also provide a control plane function for switching between the RAN 104 and other RANs (not shown) that employ other radio technologies, such as GSM or WCDMA.

The serving gateway 144 may be connected to each of the eNode Bs 140a, 140b, 140c in the RAN 104 via the S1 interface. The serving gateway 144 may generally route and forward user data packets to/from the WTRUs 102a, 102b, 102c. The serving gateway 144 may also perform other functions, such as anchoring user planes during inter-eNode B handovers, triggering paging when downlink data is available for the WTRUs 102a, 102b, 102c, managing and storing contexts of the WTRUs 102a, 102b, 102c, and the like.

The serving gateway 144 may also be connected to the PDN gateway 146, which may provide the WTRUs 102a, 102b, 102c with access to packet-switched networks, such as the Internet 110, to facilitate communications between the WTRUs 102a, 102b, 102c and IP-enabled devices.

The core network 106 may facilitate communications with other networks. For example, the core network 106 may provide the WTRUs 102a, 102b, 102c with access to circuit-switched networks, such as the PSTN 108, to facilitate communications between the WTRUs 102a, 102b, 102c and traditional land-line communications devices. For example, the core network 106 may include, or may communicate with, an IP gateway (e.g., an IP multimedia subsystem (IMS) server) that serves as an interface between the core network 106 and the PSTN 108. In addition, the core network 106 may provide the WTRUs 102a, 102b, 102c with access to the networks 112, which may include other wired or wireless networks that are owned and/or operated by other service providers.

Precoding systems provide an example application of closed-loop systems which exploit channel-side information at the transmitter (CSIT). With precoding systems, CSIT may be used with a variety of communication techniques to operate on the transmit signal before transmitting from a base station transmit antenna array. For example, precoding techniques may provide a multi-mode beamformer function to optimally match the input signal on one side to the channel on the other side. In situations where channel conditions are unstable or unknown, open loop MIMO techniques such as spatial multiplexing may be used. However, when the channel conditions can be provided to the transmitter, closed-loop MIMO techniques such as precoding may be used. Precoding techniques may be used to decouple the transmit signal into orthogonal spatial streams/beams, and additionally may be used to send more power along the beams where the channel is strong, but less or no power along the weak, thus enhancing system performance by improving data rates and link reliability. In addition to multi-stream transmission and power allocation techniques, adaptive modulation and coding (AMC) techniques may use CSIT to operate on the transmit signal before transmission from the base station array.

Precoded MIMO systems may obtain full broadband channel knowledge at the base station transmitter by using uplink sounding techniques, (e.g., with Time Division Duplexing (TDD) systems). Alternatively, channel feedback techniques may be used with MIMO systems, (e.g., with TDD or FDD) systems), to feed back channel information to the base station. One way of implementing precoding over a low rate feedback channel may be to use codebook-based precoding to reduce the amount of feedback as compared to full channel feedback.

Some MIMO systems such as MU-MIMO and CoMP may require more accurate feedback since these systems involve nulling towards co-channel users. Good nulling requires very accurate per-subcarrier CSI feedback in a MIMO Orthogonal Frequency Division Multiplexing (MIMO-OFDM) system. The CSI feedback may be provided per subband, where subband sizes may span frequencies large enough that the best precoders at different points in the subband are not the same. The subband size is approximately 800 KHz and, therefore, limits the ability of the base station to accurately place a null towards a co-channel user over the full subband with a single precoder. Although the CSI feedback subband size may be reduced, the overhead required for doing so may increase significantly. For example, reducing the subband size to 200 KHz, and thereby approximately quadrupling the required feedback overhead, may improve MU-MIMO performance by 24% in cellular channels.

LTE Release 8 (LTE R8) and 802.16m specifications may support use of one precoder feedback per subband with the assumption that a single precoder is used over that corresponding subband. The subband size may vary but is typically about 800 KHz. User equipment may assume precoding is fixed over a physical resource block (PRB). In LTE Release 10 (LTE R10), CSI feedback and precoder feedback in particular may be broken into two parts: short term and/or narrowband feedback; and long term and/or wideband feedback. Feedback may include, for example, but not limited to, Channel Quality Indicator (CQI) and Rank Indicator (RI).

An encoder and decoder at a WTRU and base station in a closed loop frequency division duplex (FDD) system handles or processes downlink (DL) channel state information (CSI) that is fed back in a compressed mode by dropping off multipath delay and angle, either in an explicit format, (full channel matrix or principal eigenvectors), or in an implicit format (codebook based). Such techniques may be applied to closed loop communications from wideband code division multiple access (WCDMA) based high speed packet access plus (HSPA+) to international mobile telecommunications (IMT)-advanced, (such as orthogonal frequency division multiplexing (OFDM)-based LTE-A, Institute of Electrical and Electronics Engineers (IEEE) 802.16m), and beyond LTE, (including coordinated multi-point (CoMP) and relay).

Time domain CSI may be compressed and fed back by dropping off some location side information, such as the number of paths, path delays, path angles, (arrival/departure), and the like. Many of the DL path properties may be estimated from those of the UL without explicit feedback signaling. Time domain feedback may offer more accurate explicit CSI independent of bandwidth, and may require much less overhead than frequency domain techniques.

In general, a method and apparatus is described in which a WTRU may compress time domain CSI without location side information, and feedback only few significant strong multipath components, where significant strong multipath components may be based on power density profiles or other channel characteristics as discussed herein below. The base station may reconstruct and transform, by fast Fourier transform (FFT), the fed back CSI to the frequency domain for precoding processing.

The WTRU may use a conventional channel estimation method, such as least square, directly in the time domain. Alternatively, the WTRU may estimate the channel response in the frequency domain and transform to the time domain with an inverse FFT (IFFT).

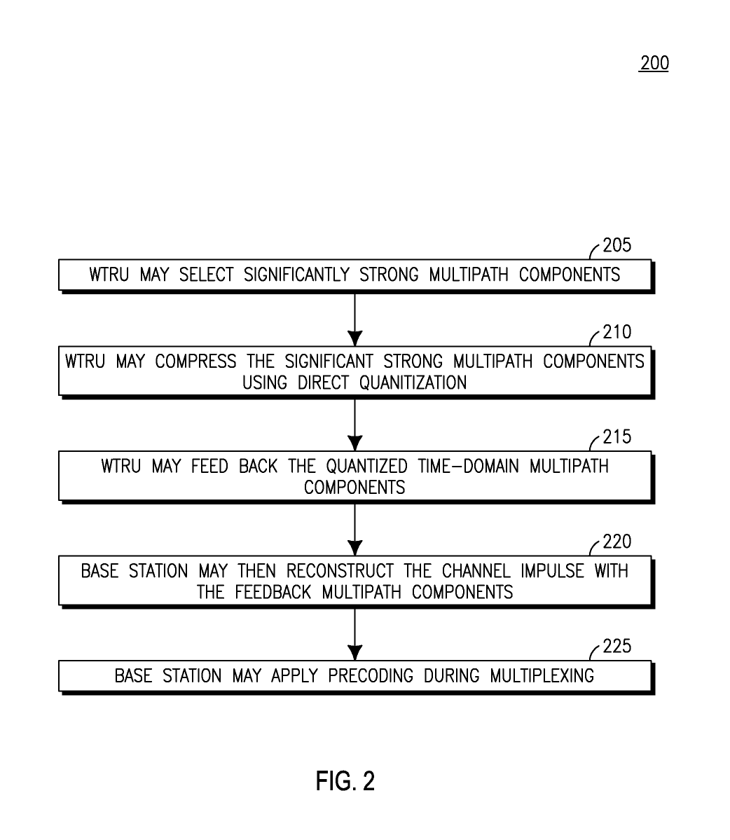

Described herein is a method for explicit time domain CSI feedback with direct quantization. An example flow chart 200 is shown in FIG. 2. In this example method, the WTRU may select significantly strong multipath components (205), compress the significant strong multipath component with direct quantization (210), and feed back the quantized time-domain multipath component (215). The base station may then reconstruct the channel impulse with the fed back multipath components (220), and apply precoding during multiplexing (225).

A time-domain multipath channel may be modeled as:

$$h ( t ) = {\sum }_{𝓁 = 1}^{L} {α}_{𝓁} δ ( t - {τ}_{𝓁} ) , \qquad Equation ( 1 )$$

where the number of non-zero paths, L, and path delay, τl, are the same as those in the UL, and αₗ are complex channel coefficients whose power delay profile (PDP) is in general decay as delay increases. The multipath location information, (number of paths, the path delays, the path angle, PDP and the like), may be computed directly at the transmitter based on the assumption that the channel statistics of the forward and reverse channels are reciprocal. In general, the principle of reciprocity may imply that that the channel is identical on the forward (downlink) and reverse (uplink) links as long as the channel is measured at the same frequency and at the same time instant.

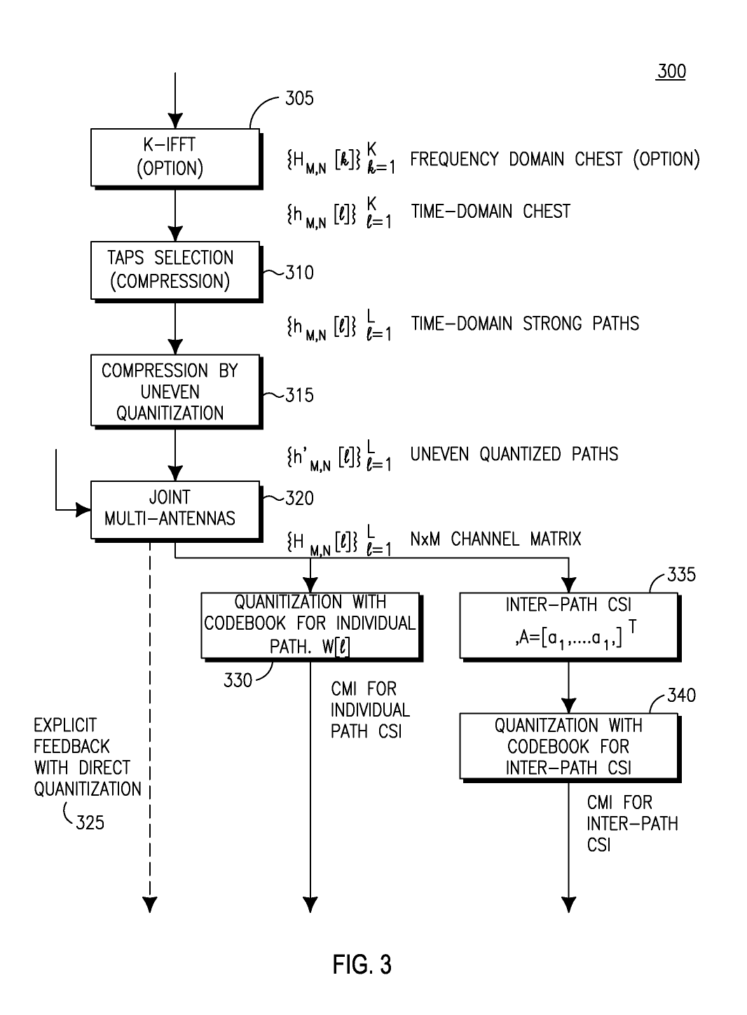

The complex multipath channel response may be estimated by a conventional algorithm such as least square (LS) estimation. Referring to flowchart 300 in FIG. 3, the channel frequency response may also be estimated in the frequency domain and transformed to the time domain via an inverse FFT (IFFT). The channel estimate or channel estimation (CHEST) in the frequency domain may denoted as {H_{m,n}[k]}ₖ₌^{K} for the k^{th} subcarrier through the m^{th} transmit antenna and the n^{th} receive antenna, where the channel is assumed to be of K subcarriers with M transmit (Tx) and N receive (Rx) antennas With IFFT, the time domain channel impulse response estimate may be {h_{m,n}[l]}ₗ₌₁^{K} (amplitude, phase, and delay), for the l^{th} path through the m^{th} transmit antenna and the n^{th} receive antenna (305).

Within all time domain non-zero channel paths that fall within a predetermined delay spread, only L strongest multipath components are selected (L<<K) (310). The remaining weaker paths (K-L) are dropped since they contribute less energy to the combiner, are more susceptible to noise and may result in additional CSI estimation errors. The number of selected paths L may be determined by a predetermined power backoff from the peak (strongest path). In this instance, the least backoff path may be the strongest path. L may also be determined by comparing the path strength, such as a signal-to-noise ratio (SNR) measurement, with a predetermined threshold. The predetermined backoff or threshold may be set as a parameter, which may be adjusted by the base station based on performance {h_{m,n}[l]}ₗ₌₁^{L}.

The time domain channel response, {h_{m,n}[l]}ₗ₌₁^{L}, may be compressed by dropping off the multipath side location information, (number of paths, the path delays, the path angle, and the PDP). The multipath side location information may be computed directly at the transmitter based on the assumption that the channel statistics of the forward and reverse channels are reciprocal. The complex amplitude coefficients, (with magnitude and phase included), of the L paths are fed back. To further reduce feedback overhead, the path complex amplitude coefficients may be first normalized to one of the paths, (e.g., the first path), so that only L−1 of the complex amplitude coefficients may need to be signaled back.

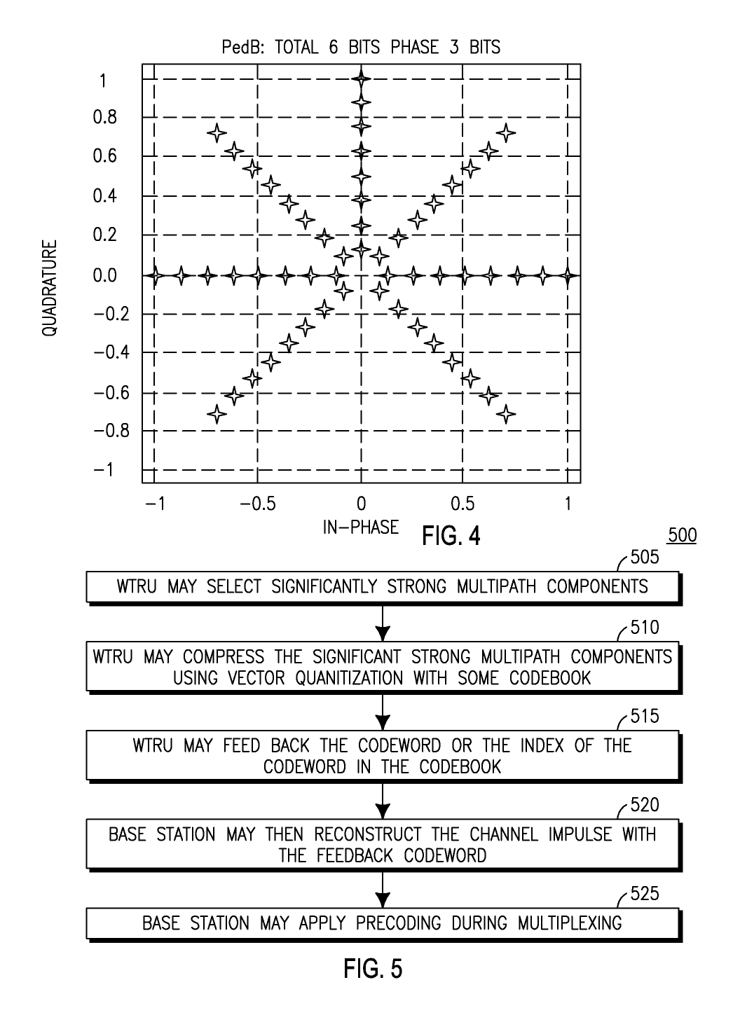

The time domain physical channel coefficients may be directly quantized as one mechanism belonging to explicit CSI feedback. In general, explicit CSI feedback/statistical information feedback may refer to a channel as observed by the receiver, without assuming any transmission or receiver processing and implicit channel state/statistical information feedback may refer to feedback mechanisms that use hypotheses of different transmission and/or reception processing, e.g., channel quality indicator/precoding matrix indicator/rank indicator (CQI/PMI/RI). The allocation of bits between magnitude and phase may be predetermined. For example, with 6 bits per channel coefficient available, 3 bits may be allocated to magnitude and 3 bits may be allocated to phase, as shown in FIG. 4.

To further reduce overhead, the complex channel coefficients may be individually quantized at unequal rates for different paths (315). The quantizer may allocate a larger number of bits to the paths with high power, and a lesser number to those with low power. The quantization bits may be determined by the long-term statistics, such as the path delay profile, and/or adaptively computed by the path power of the coefficients. The optimal bit allocation may be determined by minimizing mean squared quantization error across all paths with the constraint of total feedback bits. The processing described herein above with respect to FIG. 3 may be applicable to both explicit and implicit feedback mechanisms. With respect to multiple antennas (325), an element-by-element quantization may be performed for explicit feedback and all antennas may be handled together for implicit feedback.

At this point in FIG. 3, the processing for explicit and implicit feedback mechanisms follow different courses as described herein. In summary, explicit or direct feedback follow (325) and implicit feedback follow (330 and 335, 340).

For explicit or direct feedback, the quantized channel path coefficients and the bit allocation information for each path are sent back (325). The reporting for the two types of feedback information may be sent back with different granularities.

The base station may reconstruct the time domain channel path coefficients using the feedback CSI and multipath side location information, and may then transform using FFT to obtain the frequency domain CSI for precoding. As stated herein, the multipath side location information may be estimated by the base station. There may be some mismatch when the base station decides the number and delay of paths and the WTRU sends the path complex amplitude values. To eliminate the mismatch error, the DL path delay information may be quantized and sent back at low rates to exploit the property that delays, which presents much slower variations in time than the amplitudes.

The explicit direct quantization works with explicit CSI feedback, which generally requires a significant amount of overhead. The UL control channel may need to be changed to carry more CSI. Specifically, the physical uplink control channel (PUCCH) payload sizes containing the feedback information may need to be expanded. A threshold parameter may need to be added which is fed forward from the base station to the WTRU to select the strongest multipath components.

Described herein is implicit time domain CSI feedback based codebook quantization. Referring to flowchart 500 in FIG. 5, the WTRU may select significant strong multipath components (505), compress the significant strong path using vector quantization with some codebook (510), and feed back the codeword or the index of the codeword in the codebook (515). The codebook may be designed offline and may be known to both the WTRU and the base station. The base station may then reconstruct the channel impulse with the fed back codeword (520), and apply precoding during multiplexing (525).

This method may reduce the feedback overhead by using a codebook in the time domain. Referring back to FIG. 3, a codebook matrix may be applied to an individual path, (or a cluster of paths) (330), and an additional codebook may be applied to global magnitude/phase information between paths (335, 340). In particular, this method may apply a vector based codebook in the time domain.

The method may be shown in two stages. In a first stage, CSI may be compressed on a per-path basis, (330 in FIG. 3). For each channel path, the receiver observes a size N×M matrix {H[l]}ₗ₌₁^{L}, where N is the number of receive antennas and M is the number of transmit antennas. To proceed, the receiver may decompose the matrix channel into N length-M vector channels Hₙ[l], and may then perform compression on each vector channel for each path. The objective is to find a vector Wₙ[l] from the codebook, such that the “distance” between a selected vector scaled by a proper complex coefficient referred to as αₙ[l] in [0086], and the channel vector is minimized. The “distance” may be defined as the Euclidian distance, but other forms of distance may also be used, such as a chordal distance, subspace distances or the like. Using the Euclidian distance measure as an example:

Wₙ[l]=arg min∥αₙ[l]Wᵢ−Hₙ[l]∥=arg max(abs(Hₙ[l]Wᵢ^{H})). Equation (2)

The coefficient αₙ[l] may be introduced to provide additional freedom in quantization so that the size of the codebook may be reduced for a given quantization error requirement (shown as 335, 340 in FIG. 3). This coefficient may provide phase and amplitude information for each quantized path and may be used to determine the inter-path CSI. Its value may be calculated as:

αₙ[l]=Hₙ[l]Wₙ^{H}[l]. Equation (3)

After the first stage, the receiver may have available the total NL selected vectors, (or equivalently their indices), which are fed back to the transmitter. The receiver may also have available total NL complex coefficients that may be fed back to the transmitter. One option may be directly quantize these coefficients and feed them back. In another option, to further reduce overhead, codebook based quantization may be applied in the second stage.

In the second stage codebook quantization, (shown as 335, 340 in FIG. 3), the receiver may first assemble N length-L vectors {A′ₙ}ₙ₌₁^{N}, where:

A′ₙ=(αₙ[1], αₙ[2], . . . , αₙ[L]). Equation (4)

and normalize them such that:

$${A}_{n} = \frac{{A}_{n}^{′}}{‖ {A}_{n}^{′} ‖} . \qquad Equation ( 5 )$$

Similar to the first stage, the receiver may select a vector VₙVₙ from a codebook, such that the “distance” between the selected vector scaled by a proper complex coefficient, and the vector Aₙ Aₙ is minimized, where:

Vₙ=arg min ∥βₙVᵢ−Aₙ∥=arg max(abs(AₙVᵢ^{H})). Equation (6)

Once the vectors are selected, their indices (total N) are fed back to the transmitter. Unlike the first stage compression, there may be no need to feedback the complex scaling coefficients βₙ. Based on feedbacks Wₙ[l], and Vₙ, the transmitter may reconstruct the channel according to:

\tilde{h}_{m,n}[l]=W_{n,m}[l]V_{n,l}. Equation (7)

As mentioned earlier, the coefficients αₙ[l] may be introduced to reduce codebook size for the first stage compression. In a special case, if these coefficients are fixed to have a value of 1, then the second stage compression may be eliminated.

The codebook may be generated by iterative approaches such as a Lloyd algorithm. An off-shelf codebook, such as in LTE and IEEE 802.16e/m, may also be used if the desired performance is met. For example, for the Third Generation Partnership Project (3GPP) pedestrian B channel, the multipath channel has 6 significant paths, which is not available from LTE and 802.16e/m. The Lloyd algorithm may be used in offline search to vector quantize the inter-path vector (6 elements). Different codebook sizes may be chosen to satisfy the performance requirement.

In another example to improve performance, unequal bits may be allocated to the codebook for different paths. For example, assume 6 paths within a predetermined delay spread. For the first and second path, a large codebook may be used, (e.g., 6 bits), whereas for the remaining paths, smaller size codebooks, (e.g., 2 or 3 bits) may be used. The optimal bit allocation may be applied without loss of generality. To capture the phase and magnitude information between the paths, another codebook for the second stage compression may be used. For a single receive (Rx) antenna system (N=1), by codebook mapping, the quantized channel {H[l]}ₗ₌₁^{L} may be represented by an L channel matrix index (CMI) for individual paths (first stage), and 1 CMI for the second stage. An overall estimate of the overhead may be about a 3-6 bit precoding matrix index (PMI)×3-5 best paths=9-30 bits, which is comparable to the frequency domain feedback.

Due to the non-uniform distribution of the quantization bits for each path, an efficient channel coding, such as unequal protection code, may be used to efficiently encode the PMIs and hence reduce the number of feedback bits required. For example, an unequal protection code may be applied to the most significant bits (MSBs) of the codebook vector for global path phase information. That is, the selected strongest paths may receive the strongest protection using the strongest channel coding.

In another example, a differential approach may be applied to the codebook in which only the amplitude/phase difference may be used. This may further reduce the storage and reduce the feedback overhead. In this example, information from previous transmission time intervals (TTI) may be used to generate differential values between a current TTI and the previous TTIs. These differential values may then be processed as described herein.

To eliminate the mismatch error between the path delay decided by the base station, and complex amplitude fed back from the WTRU, the DL path delay information may be quantized and fed back with a rate much slower than the complex amplitude. A third codebook matrix may be used to represent the path delay.

The base station may decode the CMI feedback using quantization codebooks to obtain estimates of the transformed coefficients. The base station may also estimate the UL CSI. The path locations of the UL may be used as predetermined information for DL multipath locations. Subsequently, inverse transformations, (by FFT), may be applied to the quantized transformed coefficients to obtain a quantized version of the frequency domain channel response. Based on this channel information, the optimal precoder and per-stream coding rates at each frequency may be computed at the transmitter.

The path locations may be determined from long term averaging and not from short term packet by packet. One option may be to determine the complex gain per path per single-input single-output (SISO) channel such that the frequency domain error is minimized. Another option may be to find a codebook per path such that the frequency domain error is minimized. However, this may be performed jointly by searching across all paths, and the complexity may be high. Some simplifications may be possible whereby the codebook for the first path is determined, and then conditionally upon determining the codebook for the second path, and so forth, (using a frequency domain metric).

The option above may be applied in a multiple cell CoMP. The frequency domain codebook based feedback may assume a transmission set is known to the WTRU when CMI is generated. This is however not always true in CoMP. The time domain feedback may provide more benefit in the context of CoMP and/or multi-user (MU) multiple-input multiple-output (MIMO) (MU MIMO), where explicit channel feedback may work best. The time domain feedback may offer more flexibility to networks, and more accurate explicit CSI. It may also be more compatible with techniques such as differential feedback, and channel interpolation. Described herein are the physical layer procedures and signaling that may be needed to support this example method.

A codebook with optional varying-size for individual paths in the first stage, and a codebook with length L for the global magnitude/phase information between paths in the second stage may need to be specified for implementation of CMI based time-domain feedback.

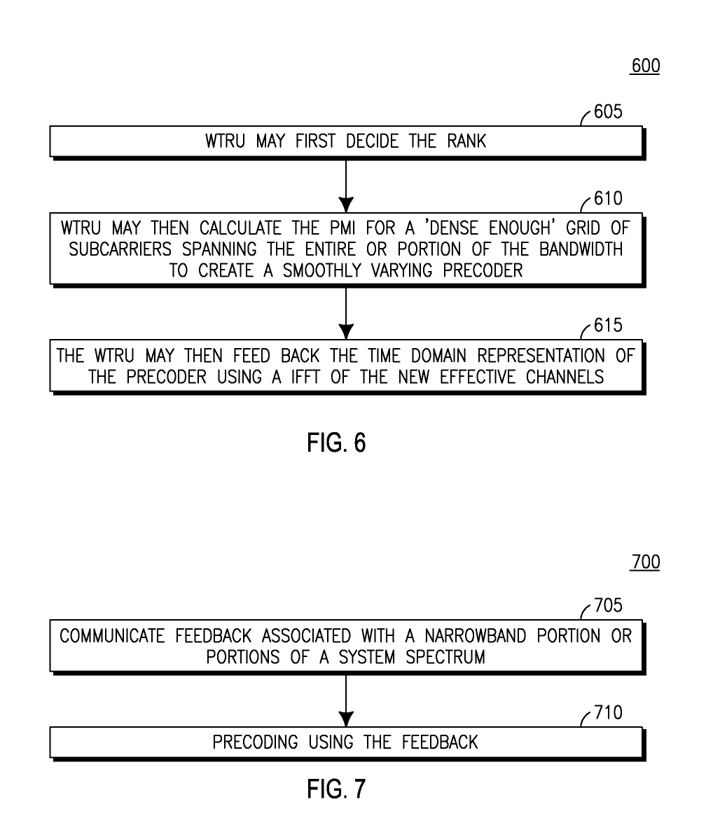

Described herein is an alternative time domain implicit CSI feedback. As shown in flowchart 600 in FIG. 6, in another method, the WTRU may first decide the rank (605), and then calculate the PMI for a ‘dense enough’ grid of subcarriers spanning the entire or portion of the bandwidth to create a smoothly varying precoder (610). The term “grid of subcarriers” may be equivalent to “subcarriers chosen . . . with good enough density over time to allow good precoding per subband or across the entire bandwidth of operation.” That is, the base station may select narrowband portions/subcarriers so that a representative sample over time and frequency may be obtained that permits a WTRU to obtain representative feedback information that permits better estimation and better precoding selection. The WTRU may then feed back the time domain representation of the precoder using an IFFT of the new effective channels (615).

As described herein, codebook based quantization may be applied to the channel itself. As was shown, the amount of overhead may increase as the number of receiver antennas increases. In one option, one may first perform singular value decomposition (SVD) to the channel matrix on a per path basis, and then apply quantization on the dominant eigenvectors of the channel matrix.

Let the SVD for the l-th path be:

H[l]=U_{L}[l]Σ[l]U_{R}^{H}[l]. Equation (8)

One may apply similar procedures as previously described, but replace row vector H[l] by U_{R,k}^{H}[l], where U_{R,k}[l] is the k-th column of U_{R}[l].

In another option, frequency domain SVD may be performed on pilot subcarriers and/or reference signal subcarriers. In case only wideband rank-1 feedback is required, phase aligning the rank-1 per subcarrier may then be performed to smooth out the impulse response. In case rank-2 feedback is required, a more sophisticated approach may be based on untangling, whereby the first and second singular vectors may be mixed to smooth out the frequency response.

A rank-1 time domain feedback may convert an M×N MIMO channel to an equivalent M×k rank-k channel using this method. A section specifying L paths with L−1 delays with each path fed back as a M×k matrix, where k denotes the rank of the channel, may need to specified to implement rank adapted time domain feedback.

Described herein is a method for providing feedback for precoding. In particular, the method provides feedback per subcarrier such that a grid of subcarriers spans a subband or the entire operating bandwidth. This allows for better frequency interpolation and hence feedback accuracy.

In this method, a preferred precoder may be selected and feedback may correspond to a narrowband portion or portions of the spectrum rather than a specified subband, (e.g., a single subcarrier). As discussed herein, the location of the narrowband portions may be based on channel characteristics. For purposes of this description, a narrowband may be greater than or equal to the smallest subcarrier but smaller than a subband. Subcarriers may be selected by the base station with good enough density over time to allow a good precoding per subband or across the entire bandwidth of operation. The precoding may be smoothly varying over contiguous allocations, where “smoothly varying” may refer to the result of precoding over a good enough grid in frequency (subcarrier based) and time, permitting the receiver to exploit frequency domain correlations in channel estimation. Short term feedback may be augmented with long term information about the channel impulse response delay profile or frequency domain correlation information. This may improve precoding granularity or accuracy.

Specifically, a WTRU may feed back short term rank adapted precoders, (or precoder factors where 2-part feedback may be used), corresponding to certain locations in the system bandwidth with certain frequency spacing. The spacing may be determined by the base station based on long term feedback or based on its own channel measurements assuming some degree of channel reciprocity. The location may also be determined by the base station on a long or short term basis. The set of locations that the WTRU may provide measurements for are signaled to the WTRU as part of the CSI/CQI reporting schedule. Some elements of the reporting schedule may be signaled via RRC messages, but some elements, (like distance between locations), may be part of broadcast system information. For example, locations similar to the locations of reference symbols (RS), (e.g., CSI-RS), may be defined. The combination of narrowbands and location selectability provides flexibility as to where the feedback information is obtained from. By way of example, emphasis may be on precoder feedback of a given rank and not the raw explicit channel state or channel covariance feedback. However, the same principles may be applied to explicit CSI feedback and other techniques.

The WTRU may also feed back long term information to aid the base station in performing precoder interpolation. One option may be that the feedback of SNR and PDP of the channel impulse response or effective channel impulse response, (as computed by an IFFT of the fed back rank adapted precoders). The SNR and PDP, may be common to all antennas of the base station and WTRU. The SNR and PDP may be used by the base station to compute a linear minimum mean squared error (LMSSE) interpolation filter using the formula:

$$W = {FR}_{h} {{F}_{p}^{*} ( {F}_{p} {R}_{h} {F}_{p}^{*} + \frac{1}{SNR} I )}^{- 1} \qquad Equation ( 9 )$$

where F is a Discrete Fourier Transform (DFT) matrix, Fp is a pruned DFT matrix containing columns for the specific locations used for precoder feedback, and Rₕ is the channel normalized autocorrelation diagonal matrix computed as:

$${R}_{h} = \frac{diag ( {σ}_{o}^{2} , … , {σ}_{L - 1}^{2} )}{{\sum }_{i = 0}^{L - 1} {σ}_{i}^{2}} \qquad Equation ( 10 )$$

where the L positive elements σᵢ² form the channel power delay profile. With longer PDP and lower antenna correlation at the base station, the base station may signal smaller spacing of the subcarriers used for precoder feedback. The PDP may be computed by averaging out the absolute square of the impulse response taps over a certain period of time, such as 50 ms.

Moreover, the WTRU may feed back the long term Doppler estimate or time correlation for time domain combining at the base station. Thus, 2-D minimum mean squared error (MMSE) interpolation of the fed back precoders may be feasible with the combined feedback of time and frequency autocorrelation.

In another example, a base station may estimate long term parameters based on uplink traffic.

In another example, a base station may specify alternating subcarriers positions in successive frames to be used for CSI feedback. In this way, the 2-D channel state, (time and frequency), may be more efficiently sampled such that the total overhead is reduced. In other words, if the WTRU feeds back CSI feedback in successive frames, the WTRU may do so for different pilot locations and/or reference signal locations so that together they provide a sufficiently dense grid over a frequency-time block. The term “sufficiently dense grid” may mean that multiple narrowband portions may be located over the operational bandwidth and some several time frames to provide useful results for precoding processing. Specific time frequency locations may change frame by frame according to a long-term sequence. For example, the sequence may sweep the frequency (sub)band subcarrier by subcarrier at each frame. The sequence may also use a predefined interleaving approach to achieve time-frequency diversity/multiplexing gain. The long-term sweeping sequence may be agreed upon between the base station and WTRU.

FIG. 7 is a flowchart 700 of an example method for providing feedback for precoding. A WTRU may communicate to a base station feedback associated with a narrowband portion or portions of a system spectrum (705). The feedback may be in accordance with the examples provided herein. The base station may receive the communication from the WTRU and may perform precoder interpolation using the feedback (710). The precoding may be smoothly varying over contiguous allocations permitting the receiver to exploit frequency domain correlations in channel estimation. Short term feedback may be augmented with long term information about the channel impulse response power delay profile or frequency domain correlation information.

Described herein are methods to facilitate the WTRU and the base station use of the attainable multipath side location information. To facilitate the use of the attainable side information, both the WTRU and the base station may have various levels of agreement on the nature of the side information using various options.

In an example method, the WTRU and the base station may agree on the number and locations of paths semi-statically, (e.g., radio resource control (RRC) signaling). The base station may perform measurements of the channel impulse response on transmissions made by the WTRU, (e.g., SRS, scheduled data transmissions), determine a set of path locations that the WTRU should assume when computing the compressed CSI, and send the set of path locations to the WTRU. The WTRU may consider differences in the path locations, (and number), it estimates versus the ones signaled to the WTRU by the base station when computing the compressed CSI, (i.e., the WTRU knows the error introduced by the misalignment of side information and may take steps to mitigate the impact of those errors).

In another example method, the WTRU may first perform channel impulse response measurements on transmissions made by the base station, (e.g., channel sounding response (CSR), physical downlink control channel (PDCCH), and/or physical downlink shared channel (PDSCH)), estimate the number and locations of transmission paths, and send the base station a set of suggested transmission path locations to assume. The base station may (or may not) also perform channel impulse response measurements of transmissions made by the WTRU, (e.g., sounding reference signal (SRS), or scheduled data transmissions), determine a set of transmission path locations that the WTRU should assume when computing the compressed CSI, and send the set of path locations to the WTRU.

In another example method, the WTRU may first perform channel impulse response measurements on transmissions made by the base station (e.g., CSR, PDCCH, and/or PDSCH), estimate the number and locations of transmission paths, and send the base station a set of transmission path locations to assume. The NB accepts the set of path locations to assume in subsequent compressed CSI reports.

In each of the above example methods, the WTRU may request an update of the agreed side information, the base station may decide to update the agreed side information, or the WTRU may send updates or an update request at predetermined, (e.g., scheduled), update opportunities. Implementation may require addition that specifies agreement between the WTRU and the base station on the number of and locations of paths semi-statically, (e.g., RRC signaling).

Described herein are example methods to implement the codebook based implicit time domain feedback. The examples are focused on single user (SU) rank-1 and may be extended to MU-MIMO with higher rank MIMO cases and CoMP. The overall system bandwidth may be assumed to be 5 MHz. The number of subcarriers may be 300, with 25 resource blocks (12 subcarriers each). The subcarrier spacing may be 15 kHz. A subband may contain 5 resource blocks. The numbers are for illustration purposes and other numbers and combinations may be used.

A 3GPP spatial channel model with the pedestrian B channel profile may be simulated in a micro-cell environment. Perfect channel estimation may be assumed with perfect feedback. The path delays may be known in the base station. The codebook for the inter-path CSI quantization is designed with Lloyd's algorithm in vector quantization by the nearest neighbor rule according to a distance measure, where:

$$d ( w , h ) = - ‖ {w}^{H} h ‖ = - \vert {\sum }_{i}^{ } {w}_{i} \cdot {h}_{i} \vert \qquad Equation ( 11 )$$

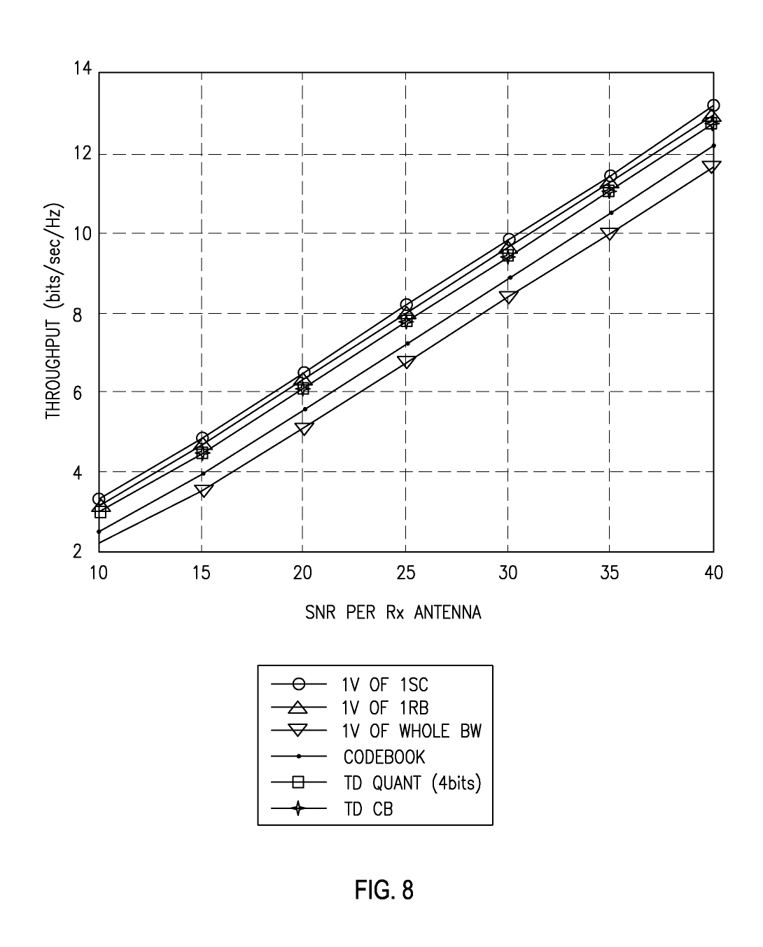

FIGS. 8-15 may use the legends listed in Table 1.

TABLE 1
1V of 1SC: feedback V per subcarrier (in frequency domain);
1V of 1RB: feedback one V per resource block (RB) (in frequency
domain);
1V of entire bandwidth: feedback one V per entire bandwidth (in
frequency domain)
Codebook: feedback an LTE codebook per subband = 5 RBs (in frequency
domain);
TD Quant: explicitly feedback directly quantized multipath components
(e.g., 4 bits per path per Rx/Tx pair(2 bits for phase, 2 bits for magnitude);
and
TD CB: implicitly feedback a codebook per path, and feedback one
additional non-quantized inter-path CSI,
where V is an eigenvector

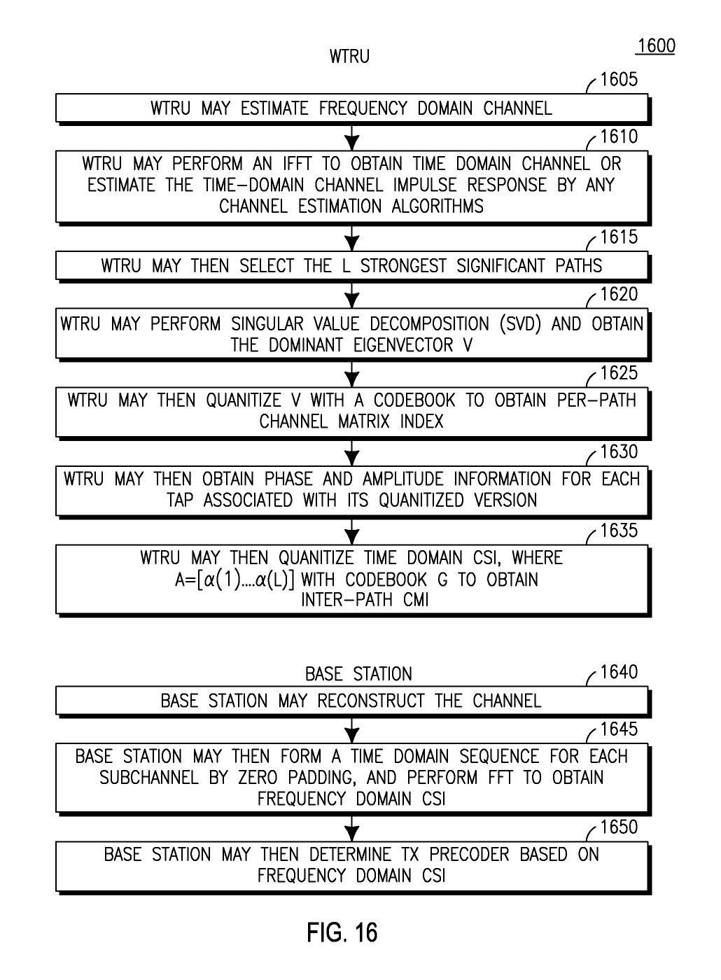

Example 1, with reference to flowchart 1600 in FIG. 16, describes a procedure for the codebook-based implicit time-domain feedback in multiple-input single-output (MISO). The WTRU may initially estimate a frequency domain channel, {H_{m,1}[k]}ₖ₌₁^{K} (optionally) (1605). The WTRU may perform an IFFT to obtain time domain channel, {h_{m,1}[l]}ₗ₌₁^{K}, or estimate the time-domain channel impulse response by any channel estimation algorithms (1610). The

WTRU may then select the L strongest significant paths, {h_{m,1}[l]}ₗ₌₁^{L} (1615). The selection may make use of long-term PDP with instantaneous path power estimated from the WTRU. The WTRU may perform singular value decomposition (SVD) and obtain the dominant eigenvector V of {h_{m,1}[l]}ₗ₌₁^{L} (1620), where:

h[l]=UDV^{H}. Equation (12)

The WTRU may then quantize V with a codebook to obtain per-path channel matrix index (CMI) (1625), where:

\tilde{W}(l)=arg max(abs(V(:,1)^{H}·con j(w))). Equation (13)

The WTRU may then obtain phase and amplitude information for each tap or path associated with its quantized version (1630):

α(l)=D(1,1)V(:,1)^{H}·con j(\tilde{W}). Equation (14)

The WTRU may then quantize time domain CSI A=[α(1) . . . α(L)]^{T} with codebook G to obtain inter-path CMI (1635), where:

G=arg max(([abs(G)]^{H} A)). Equation (15)

The WTRU feedback is per path CMI, \tilde{W}; inter-path CMI, G; and path delay information with slow rate.

The base station may reconstruct the channel (1640), where the effective channel for l-path:

\tilde{h}[l]=g(l)\tilde{W}^{T}(l) Equation (16)

The base station may then form a time domain sequence for each subchannel by zero padding, and perform FFT to obtain frequency domain CSI (1645). The base station may then determine Tx precoder based on frequency domain CSI (1650).

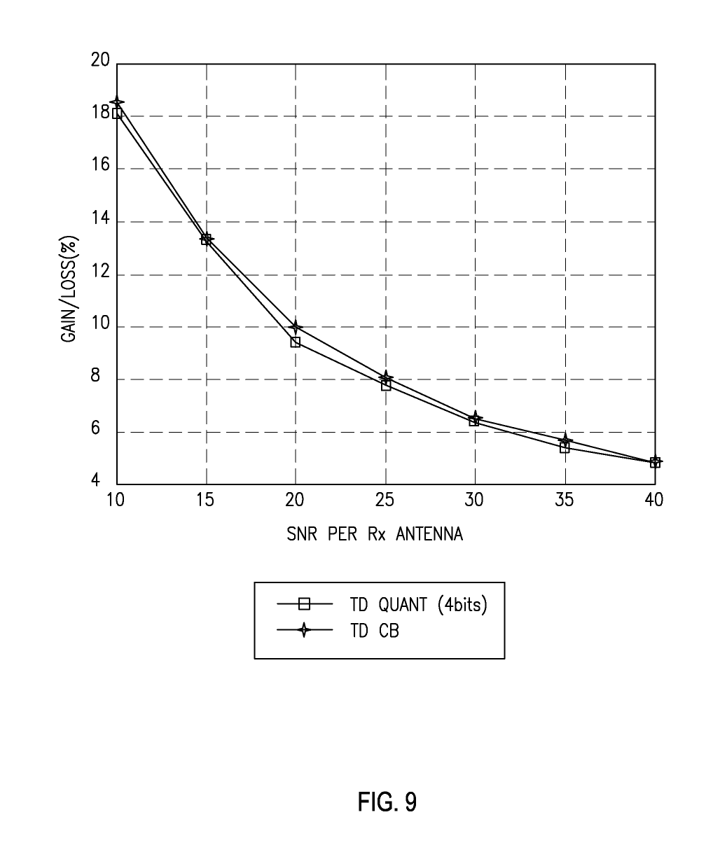

FIGS. 8 and 9 illustrate the throughput advantage compared with frequency domain LTE codebook based feedback for a 4×1 channel. The implicit time domain feedback uses an IEEE 802.16m codebook to quantize the per-path CSI, and an 8-bit codebook, (designed using Lloyd algorithm offline), to quantize the inter-path CSI. The total number of bits for overhead is 6 bits/path×6 paths+8 bits inter-path=44 bits. As a comparison, the frequency domain LTE codebook based feedback uses 4 bits/RB×25 RBs=100 bits.

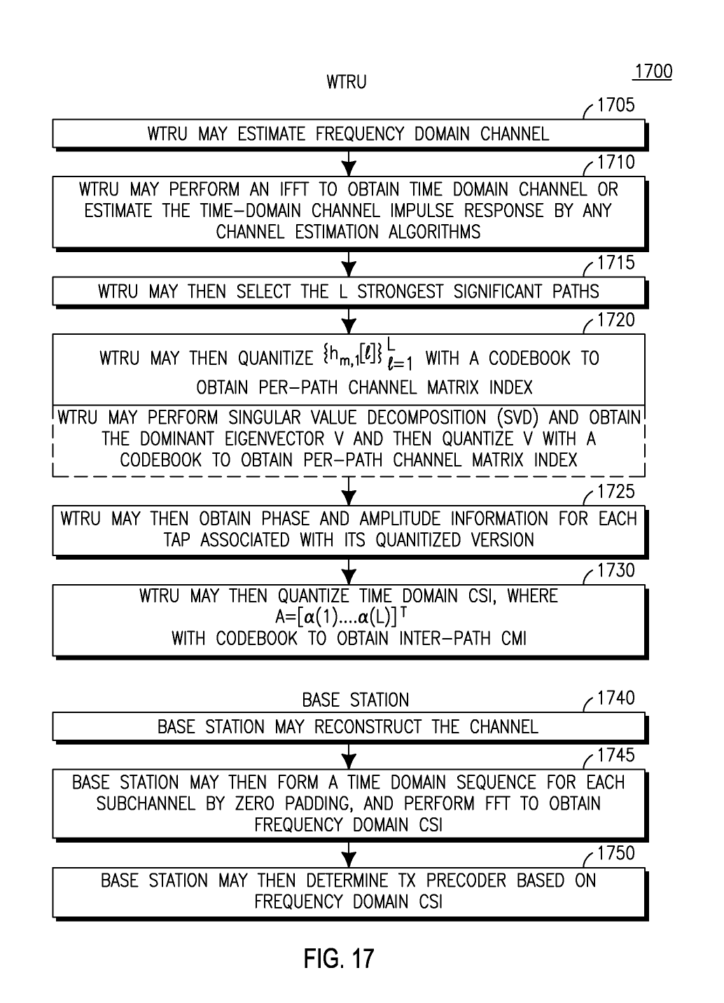

Example 2, with reference to flowchart 1700 in FIG. 17, describes another procedure for the codebook-based implicit time-domain feedback in MISO.

The WTRU initially may estimate a frequency domain channel {H_{m,1}[K]{ₖ₌₁^{K}. (1705) and then may perform an IFFT to obtain time domain channel, {h_{m,1}[l]}ₗ₌₁^{K}, or estimate the time-domain channel impulse response by any channel estimation algorithms (1710).

The WTRU may then select the L strongest significant paths, {h_{m,1}[l]}ₗ₌₁^{L} (1715). The selection may make use of long-term PDP with instantaneous path power estimated from WTRU.

The WTRU may then quantize {h_{m,1}[l]}ₗ₌₁^{L} with a codebook to obtain per-path CMI (1720), where:

\tilde{W}(l)=arg max(abs(h_{m,1}[l]·(Wᵢ^{H}))). Equation (17)

or equivalently, may perform SVD and obtain the dominant eigenvector V of {h_{m,n}[l]}ₗ₌₁^{L}, where h[l]=UDV^{H}, and then quantize V with a codebook to obtain per-path channel matrix index (CMI), where:

\tilde{W}(l)=arg max(abs(V(;,1)^{H}·con j(W))). Equation (18)

The WTRU may then obtain phase and amplitude information for each tap or path associated with the quantized version (1725), where:

α(l)=h(l)·con j(\tilde{W}) Equation (19)

The WTRU may then quantize time domain CSI A=[α(1) . . . α(L)]^{T} with codebook G to obtain inter-path CMI (1730).

The WTRU feedback may be per path CMI, \tilde{W}; inter-path CMI, G; and path delay information with slow rate.

The base station may reconstruct the channel (1740), where the effective channel for l-path:

\tilde{h}[l]=g(l)\tilde{W}^{T}(l). Equation (20)

The base station may then form time domain sequence for each subchannel by zero padding, and perform FFT to obtain frequency domain CSI (1745). The base station may then determine a Tx precoder based on frequency domain CSI (1750).

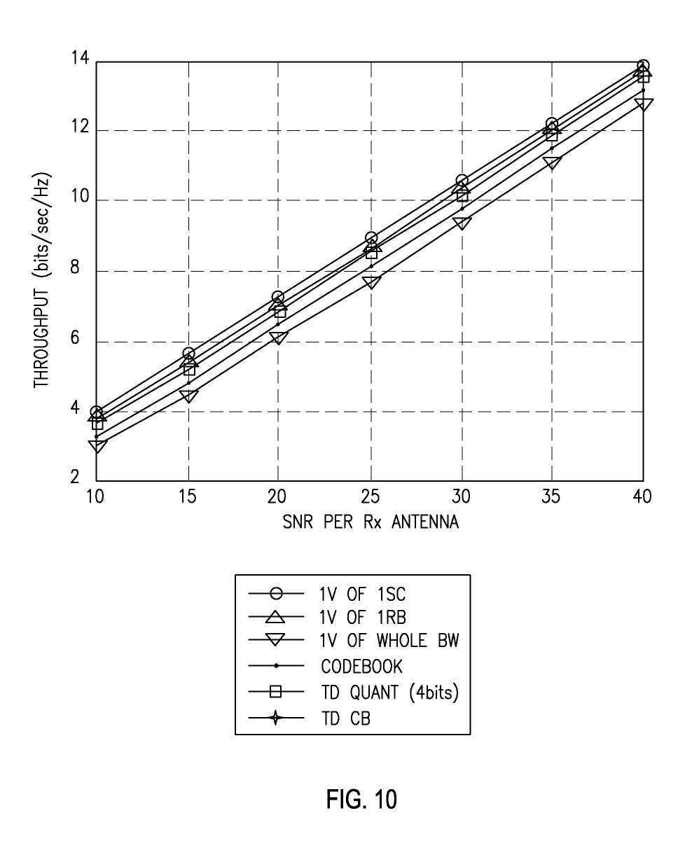

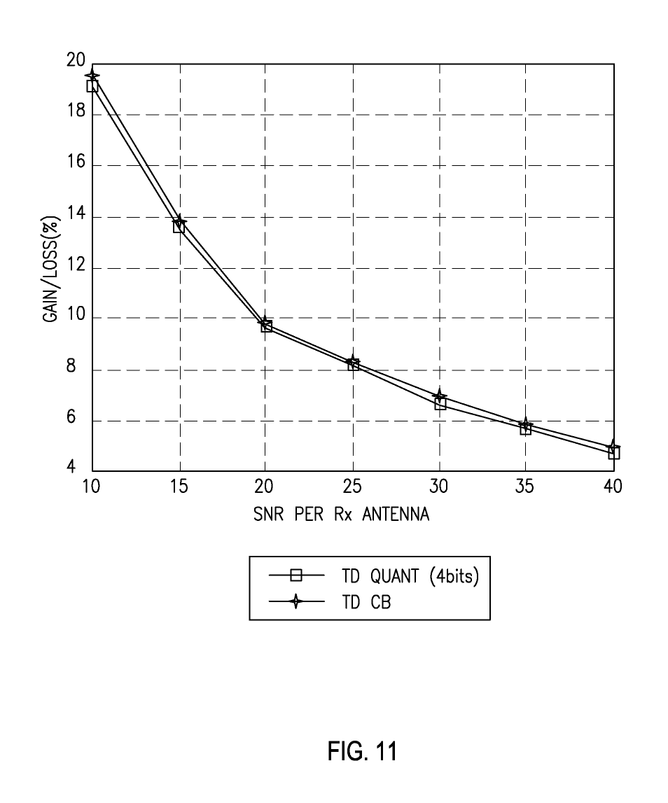

FIGS. 10 and 11 illustrate the throughput advantage compared with frequency domain LTE codebook based feedback for 4×1 channel. The implicit time domain feedback uses an IEEE 802.16m codebook to quantize the per-path CSI, and the inter-path CSI is directly quantized.

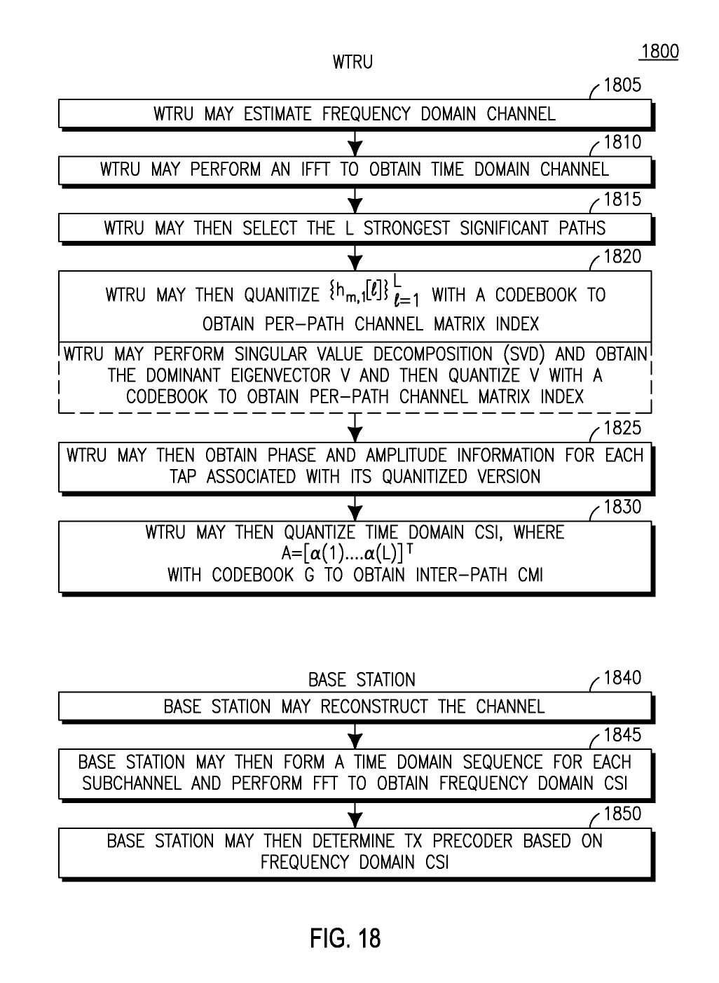

Example 3, with reference to flowchart 1800 in FIG. 18, describes a procedure for the codebook-based implicit time-domain feedback in MIMO, i.e., splitting MIMO as several MISO.

The WTRU may initially estimate frequency domain channel, {H_{m,n}[k]}ₖ₌₁^{K} (1805) and may then perform IFFT to obtain time domain channel, {h_{m,n}[l]}ₗ₌₁^{K} (1810). The WTRU may then select the L strongest significant paths, {h_{m,n}[l]}ₗ₌₁^{L} (1815).

Step 4: Quantize {h_{m,n}[l]}ₗ₌₁^{L} with codebooks to obtain per-path CMI (1820), where:

\tilde{W}(l)=arg max(abs(h_{m,1}[l]·(Wᵢ^{H}))). Equation (21)

or equivalently may perform SVD and obtain the eigenvectors V of {h_{m,n}[l]}ₗ₌₁^{L}, where:

hₙ[l]=UDVₙ^{H}, Equation (22)

and then quantize Vₙ with a codebook to obtain per-path CMI, where:

\tilde{W}ₙ (l)=arg max(abs(Vₙ(:,1)^{H}·con j(W))). Equation (23)

The WTRU may then obtain phase and amplitude information for each tap or path associated with its quantized version (1825), where:

αₙ(l)=Dₙ(1,1)Vₙ(:,1)·con j(\tilde{W}ₙ). Equation (24)

The WTRU may then quantize time domain CSI, where:

Aₙ=[αₙ(1) . . . αₙ(L)]^{T}. Equation (25)

with codebook Gₙ to obtain N parallel inter-path CMIs.

The WTRU feedback may be per path CMI, \tilde{W} \tilde{W}ₙ; inter-path CMI, Gₙ; and path delay information with slow rate.

The base station may reconstruct the channel (1840), where the effective channel for l-path:

\tilde{h}ₙ[l]=gₙ(l)\tilde{W}ₙ^{T}(l) Equation (26)

The base station may then form time domain sequence for each subchannel, and perform FFT to obtain frequency domain CSI (1845). The base station may then determine the Tx precoder based on frequency domain CSI (1850).

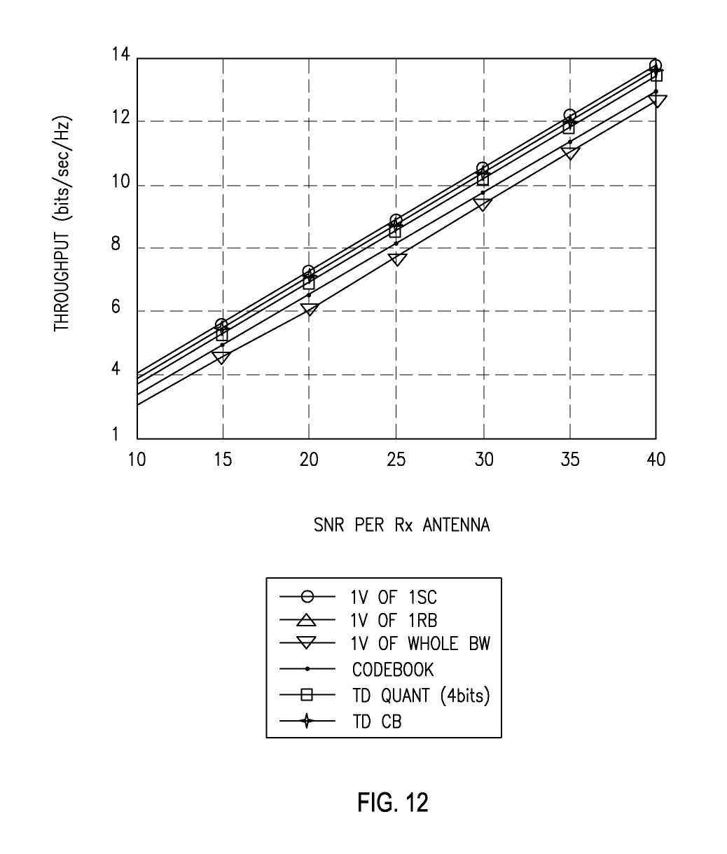

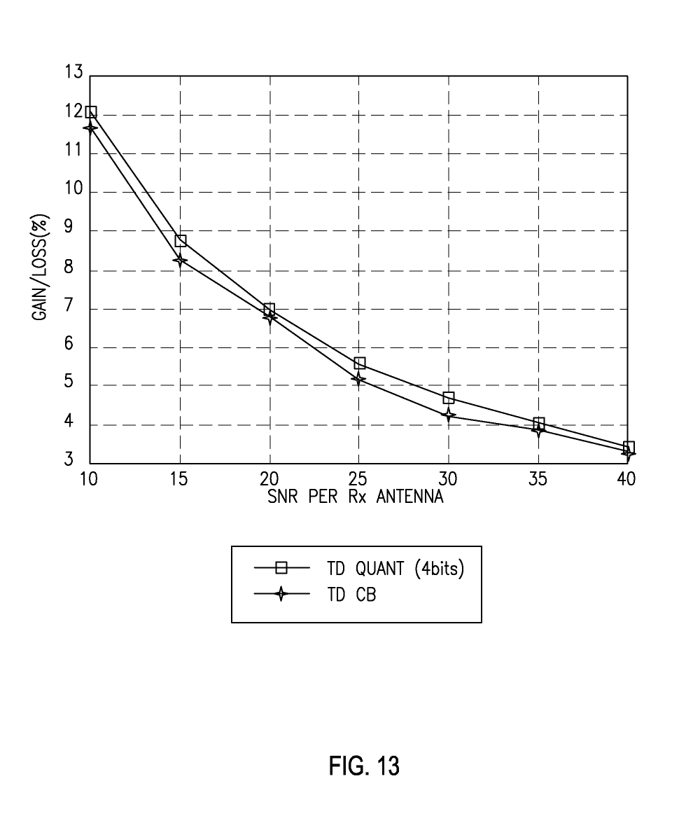

FIGS. 12 and 13 illustrate the throughput advantage compared with frequency domain LTE codebook based feedback for a 4×2 channel.

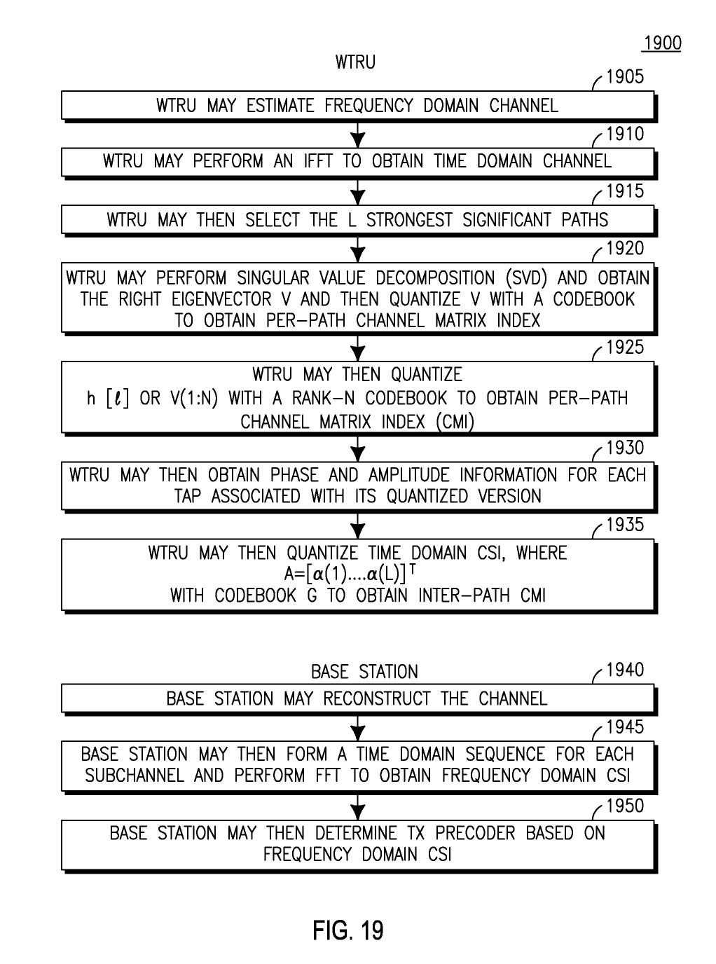

Example 4, with reference to flowchart 1900 in FIG. 19, describes another procedure for the codebook-based implicit time-domain feedback in MIMO, i.e., applying a rank-N codebook for N Rx antennas.

The WTRU may initially estimate frequency domain channel, {H_{m,n}[k]}ₖ₌₁^{K} (1905) and may perform IFFT to obtain time domain channel, {h_{m,n}[l]}ᵢ₌₁^{K} (1910). The WTRU may then select the L strongest significant paths, {h_{m,n}[l]}ₗ₌₁^{L} (1915).

The WTRU may then perform SVD and obtain the right eigenmatrix V of {h_{m,n}[l]}ₗ₌₁^{L} (1920), where:

h[l]=UDV^{H}, Equation (27)

and the first N column of V are selected. The WTRU may then quantize h[l] or V(1:N) with a rank-N codebook to obtain per-path channel matrix index (CMI) (1925), where:

$$\begin{matrix} \tilde{W} ( 𝓁 ) = arg max ( det ( h [ 𝓁 ] W ) ) , \\ or & Equation ( 28 ) \\ \tilde{W} ( 𝓁 ) = arg max ( {log}_{2} \{ det ( {I}_{n} + {\frac{SNR}{N} [ h [ 𝓁 ] W ] [ h [ 𝓁 ] W ]}^{H} ) \} ) . & Equation ( 29 )\end{matrix}$$

The WTRU may then obtain phase and amplitude information for each tap or path associated with its quantized version (1930), where:

α(l)=h[l]·con j(\tilde{W}). Equation (30)

The WTRU may then quantize time domain CSI (1935), where:

Aₙ=[αₙ(1) . . . αₙ(L)]^{T}, Equation (31)

with codebook Gₙ to obtain N parallel inter-path CMIs.

The WTRU feedback may be per path CMI, \tilde{W}ₙ; inter-path CMI, Gₙ; and path delay information with slow rate.

The base station may reconstruct the channel (1940), where the effective channel for l-path:

\tilde{h}ₙ[l]=gₙ(l)\tilde{W}ₙ^{T}(l). Equation (32)

The base station may then form time domain sequence for each subchannel, and perform FFT to obtain frequency domain CSI. The base station may then determine the Tx precoder based on frequency domain CSI (1950).

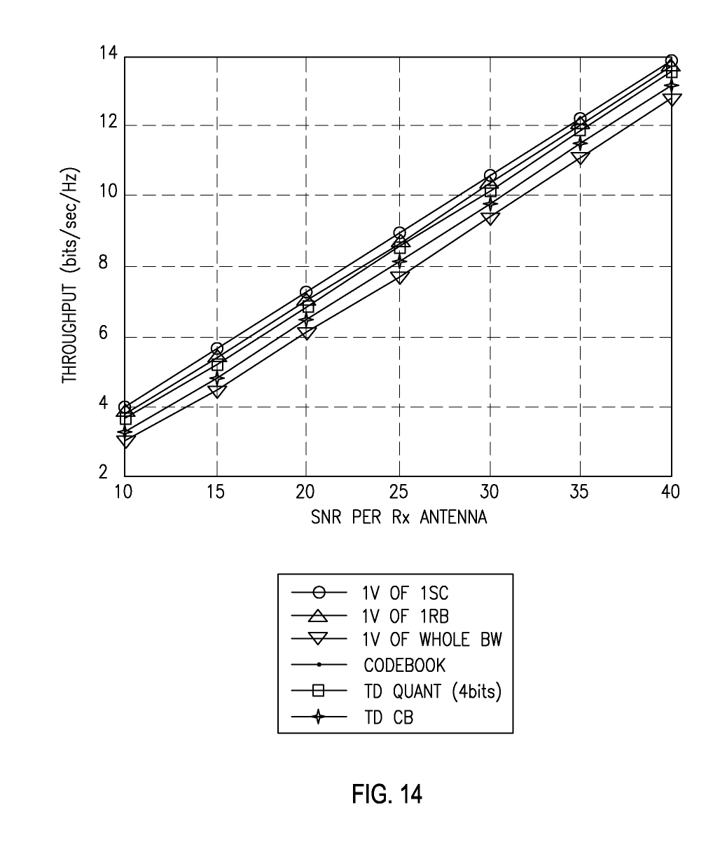

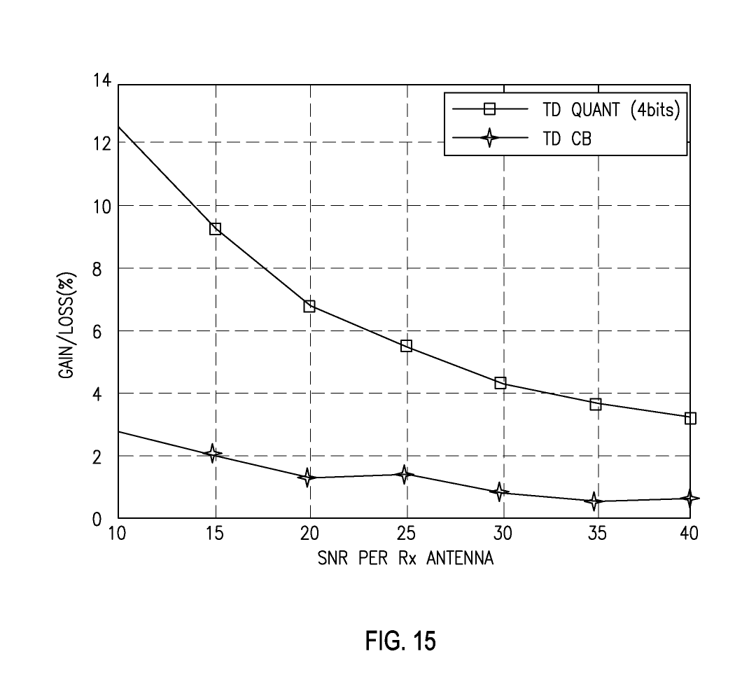

FIGS. 14 and 15 illustrate the throughput advantage compared with frequency domain LTE codebook based feedback for a 4×2 channel.

In general, a method implemented by a wireless transmit/receive unit (WTRU) for reducing feedback overhead is described herein. The method includes selecting a predetermined number of multipath components based on at least one channel characteristic and transmitting a compressed predetermined number of multipath components to a base station. The predetermined number of multipath components are compressed by using quantization. The predetermined number of multipath components may be quantized using direct quantization in the time domain or quantized using vector quantization in the time domain. The quantization may be done by quantizing the predetermined number of multipath components with a first codebook to obtain per-path channel matrix index (CMI). The quantizing may further include obtaining phase and amplitude information for each quantized multipath component and quantizing the phase and amplitude information for each quantized multipath component with a second codebook to obtain inter-path CMI. The compressed predetermined number of multipath components may be in the form of a codeword or a codebook index.

The quantizing may further include performing a singular value decomposition (SVD) on a channel matrix for each multipath component and obtaining a dominant eigenvector, quantizing the dominant eigenvector with a codebook to obtain a per-path channel matrix index (CMI), obtaining phase and amplitude information for each path associated with quantized eigenvector and quantizing phase and amplitude information with a second codebook to obtain inter-path CMI.

A method implemented at a wireless transmit/receive unit and a base station provides feedback for precoding is also described herein. The method includes communicating feedback associated with a narrowband portion of a system spectrum to a base station, wherein the narrowband portion locations in the system spectrum are based on channel characteristics and have a bandwidth size between a subcarrier and a subband. The locations may be time frequency locations that change frame to frame. The feedback may then be applied for precoding processing. The method may further include augmenting the feedback with long term information. The method may use two dimensional interpolation for precoding processing.

### Embodiments

1. A method, implemented by a wireless transmit/receive unit (WTRU), of reducing feedback overhead, the method comprising selecting a predetermined number of multipath components based on at least one channel characteristic.

2. The method of embodiment 1, further comprising transmitting a compressed predetermined number of multipath components to a base station.

3. The method of any of the embodiments, further comprising compressing the predetermined number of multipath components using quantization, wherein the compressed predetermined number of multipath components is a quantized predetermined number of multipath components.

4. The method of any of the embodiments, wherein the predetermined number of multipath components are quantized using direct quantization in a time domain.

5. The method of any of the embodiments, wherein the predetermined number of multipath components are quantized using vector quantization in a time domain.

6. The method of any of the embodiments, wherein quantizing further comprises quantizing the predetermined number of multipath components with a first codebook to obtain per-path channel matrix index (CMI).

7. The method of any of the embodiments, wherein quantizing further comprises obtaining phase and amplitude information for each quantized multipath component.

8. The method of any of the embodiments, wherein quantizing further comprises quantizing the phase and amplitude information for each quantized multipath component with a second codebook to obtain inter-path CMI.

9. The method of any of the embodiments, wherein the compressed predetermined number of multipath components is in the form of a codeword or a codebook index.

10. The method of any of the embodiments, wherein quantizing further comprises performing a singular value decomposition (SVD) on a channel matrix for each multipath component and obtaining a dominant eigenvector.

11. The method of any of the embodiments, wherein quantizing further comprises quantizing the dominant eigenvector with a codebook to obtain a per-path channel matrix index (CMI).

12. The method of any of the embodiments, wherein quantizing further comprises obtaining phase and amplitude information for each path associated with quantized eigenvector.

13. The method of any of the embodiments, wherein quantizing further comprises quantizing phase and amplitude information with a second codebook to obtain inter-path CMI.

14. A method, implemented at a wireless transmit/receive unit and a base station, for providing feedback for precoding, the method comprising communicating feedback associated with a narrowband portion of a system spectrum to a base station, wherein narrowband portion locations in the system spectrum are based on channel characteristics and have a bandwidth size between a subcarrier and a subband.

15. The method of embodiment 14, further comprising applying the feedback for precoding processing.

16. The method of any of embodiments 14-15, further comprising augmenting the feedback with long term information.

17. The method of any of embodiments 14-16, wherein two dimensional interpolation is used for precoding processing.

18. The method of any of embodiments 14-17, wherein the locations are time frequency locations that change frame to frame.

19. A method, implemented by a wireless transmit/receive unit (WTRU), of compressing channel state information (CSI), the method comprising performing channel impulse response measurements on transmissions made by an evolved Node-B (eNB).

20. The method of embodiment 19, further comprising estimating a number and locations of transmission paths.

21. The method of any of embodiments 19-20, further comprising sending to the eNB a set of suggested transmission path locations to assume in subsequent compressed CSI reports.

22. A method, implemented by a wireless transmit/receive unit (WTRU), of compressing channel state information (CSI), the method comprising receiving a set of suggested transmission path locations to assume in subsequent compressed CSI reports.

23. The method of embodiment 22, further comprising estimating a number and locations of transmission paths.

24. The method of any of embodiments 22-23, further comprising computing compressed CSI based on the suggested transmission path locations and the estimated number and locations of transmission paths.

25. A method, implemented by a wireless transmit/receive unit (WTRU), of reducing feedback overhead, the method comprising estimating a frequency domain channel.

26. The method of embodiment 22, further comprising performing an inverse fast Fourier transform (IFFT) to obtain a time domain channel.

27. The method of any of embodiments 25-26, further comprising selecting a predetermined number of strongest significant transmission paths.

28. The method of any of embodiments 25-27, further comprising performing a singular value decomposition (SVD) and obtain a dominant eigen vector.

29. The method of any of embodiments 25-28, further comprising quantizing the dominant eigen vector with a codebook to obtain a per-path channel matrix index (CMI).

30. The method of any of embodiments 25-29, further comprising obtaining phase and amplitude information for each tap associated with the quantized eigen vector.

31. The method of any of embodiments 25-30, further comprising quantizing time domain channel state information (CSI) with a second codebook to obtain inter-path CMI.

32. A method, implemented by a wireless transmit/receive unit (WTRU), of reducing feedback overhead, the method comprising estimating a frequency domain channel.

33. The method of embodiment 32, further comprising performing an inverse fast Fourier transform (IFFT) to obtain a time domain channel.

34. The method of any of embodiments 32-33, further comprising selecting a predetermined number of strongest significant transmission paths.

35. The method of any of embodiments 32-34, further comprising quantizing the strongest significant transmission paths with a first codebook to obtain per-path channel matrix index (CMI).

36. The method of any of embodiments 32-35, further comprising obtaining phase and amplitude information for each tap associated with the quantized transmission paths.

37. The method of any of embodiments 32-36, further comprising quantizing time domain channel state information (CSI) with a second codebook to obtain inter-path CMI.

38. A method, implemented by an evolved Node-B (eNB), of compressing channel state information (CSI), the method comprising performing channel impulse response measurements on transmissions made by a wireless transmit/receive unit (WTRU).

39. The method of embodiment 38, further comprising determining a set of transmission path locations for the WTRU to assume when computing compressed CSI.

40. The method of any of embodiments 38-39, further comprising sending the set of transmission path locations to the WTRU.

41. A method, implemented by an evolved Node-B (eNB), of compressing channel state information (CSI), the method comprising receiving a set of suggested transmission path locations to assume in subsequent compressed CSI reports.

42. The method of embodiment 41, further comprising estimating a number and locations of transmission paths.

43. The method of any of embodiments 41-42, further comprising computing compressed CSI based on the suggested transmission path locations and the estimated number and locations of transmission paths.

44. A method for providing feedback for precoding, the method comprising communicating to a base station feedback associated with a narrow band portion or portions of a system spectrum.

45. A wireless transmit/receive unit (WTRU) configured to perform the method as in any of the embodiments 1-44.

46. A wireless communications system configured to perform as in any of the embodiments 1-44.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

What is claimed is:

1. A method, implemented by a wireless transmit/receive unit (WTRU), of reducing feedback overhead, the method comprising:
selecting a predetermined number of multipath components based on at least one channel characteristic; and
transmitting a compressed predetermined number of multipath components to a base station.

2. The method of claim 1, further comprising:
compressing the predetermined number of multipath components using quantization, wherein the compressed predetermined number of multipath components is a quantized predetermined number of multipath components.

3. The method of claim 2, wherein the predetermined number of multipath components are quantized using direct quantization in a time domain.

4. The method of claim 2, wherein the predetermined number of multipath components are quantized using vector quantization in a time domain.

5. The method of claim 4, wherein quantizing further comprises:
quantizing the predetermined number of multipath components with a first codebook to obtain per-path channel matrix index (CMI).

6. The method of claim 5, wherein quantizing further comprises:
obtaining phase and amplitude information for each quantized multipath component; and
quantizing the phase and amplitude information for each quantized multipath component with a second codebook to obtain inter-path CMI.

7. The method of claim 6, wherein the compressed predetermined number of multipath components is in the form of a codeword or a codebook index.

8. The method of claim 4, wherein quantizing further comprises:
performing a singular value decomposition (SVD) on a channel matrix for each multipath component and obtaining a dominant eigenvector;
quantizing the dominant eigenvector with a codebook to obtain a per-path channel matrix index (CMI);
obtaining phase and amplitude information for each path associated with quantized eigenvector; and
quantizing phase and amplitude information with a second codebook to obtain inter-path CMI.

9. A method, implemented at a wireless transmit/receive unit and a base station, for providing feedback for precoding, the method comprising:
communicating feedback associated with a narrowband portion of a system spectrum to a base station, wherein narrowband portion locations in the system spectrum are based on channel characteristics and have a bandwidth size between a subcarrier and a subband; and
applying the feedback for precoding processing.

10. The method of claim 9, further comprising:
augmenting the feedback with long term information.

11. The method of claim 10, wherein two dimensional interpolation is used for precoding processing.

12. The method of claim 9, wherein the locations are time frequency locations that change frame to frame.

13. A wireless transmit/receive unit (WTRU) for reducing feedback overhead, comprising:
a processor configured to select a predetermined number of multipath components based on at least one channel characteristic;
the processor configured to quantize the predetermined number of multipath components with a codebook to obtain per-path channel matrix index (CMI); and
a transmitter configured to send back one of a codeword or a codebook index to the base station.

14. The WTRU of claim 13, further comprising:
the processor configured to obtain phase and amplitude information for each quantized multipath component; and
the processor configured to quantize time domain channel state information (CSI) with a second codebook to obtain inter-path CMI.

15. A wireless communications system for reducing feedback overhead, comprising:
a wireless transmit/receive unit (WTRU) including a processor and a transmitter,
wherein the processor is configured to select a predetermined number of multipath components based on at least one channel characteristic,
wherein the processor is configured to quantize the predetermined number of multipath components in a time domain, and
wherein the transmitter is configured to send a quantized predetermined number of multipath components; and
a base station including a receiver and a processor,
wherein the receiver is configured to receive the quantized predetermined number of multipath components,
wherein the processor is configured to reconstruct a channel impulse response from the quantized predetermined number of multipath components, and
wherein the processor is configured to apply the channel impulse response for precoding processing.

16. The system of claim 15, wherein the base station further comprises:
the processor configured to estimate a multipath side location information from uplink channel statistics.

17. The system of claim 15, wherein the base station further comprises:
the processor configured to obtain long term feedback information; and
the processor configured to augment the quantized predetermined number of multipath components with long term information.
